(19) United States
(12) Patent Application Publication
(10) Pub. No.: US 2026/0202675 A1
(43) Pub. Date: Jul. 16, 2026

(54) ULTRATHIN VIDEO AND AUDIO WEARABLES

(71) Applicant: BRELYON, Inc., San Mateo, CA (US)

(72) Inventors: Barmak Heshmat Dehkordi, San Mateo, CA (US); Christopher Barsi, Lee, NH (US)

(73) Assignee: BRELYON, Inc., San Mateo, CA (US)

(21) Appl. No.: 19/024,146

(22) Filed: Jan. 16, 2025

(51) Int. Cl. G02B 27/01; G02B 26/10; G02B 27/09; G06F 3/16

(52) U.S. Cl. CPC G02B 27/0176; G02B 26/103; G02B 27/0172; G02B 27/0944; G06F 3/167; G02B 2027/013

(57) ABSTRACT

Ultrathin video and audio wearable devices include a multimedia wearable device having an optical subsystem comprising a plurality of components, including a light source and a light exit module coupled to the light source. In some embodiments, a mechanical actuator scans a component of the optical system laterally along a primary direction, and a virtual image spanning the area swept out by the components is formed.

### FIELD OF THE INVENTION

The present invention relates to multimedia devices that provide a user with content, such as auditory or visual content. Such devices may be portable and wearable so that a user may operate them without being tethered to a particular location. Visual content includes virtual images that are visible by either or both eyes and that may provide one or more depth cues, such as a monocular depth cue or a binocular depth cue. In some embodiments, lateral mechanical scanning is implemented to increase a lateral dimension of the imagery while simultaneously reducing the form factor of the device.

### BACKGROUND

Due to advancements in electronics, optics, and fabrication techniques, there is increasing movement toward immersive display systems, such as lightfield-based or (auto)stereoscopic-based systems. Some systems are wearable, i.e., they are portable devices that are worn as an accessory on the human body. Some of these devices provide virtual reality (VR), augmented reality (AR), mixed reality (MR), or, more generally, extended reality (XR). These include, for example VR headsets and AR glasses. Many such immersive displays, however, suffer from discomfort, e.g., eye fatigue from the vergence-accommodation mismatch, burdensome carrying weight, or uncomfortable temperatures from the heat generated by one or more system components.

### SUMMARY

Some aspects of the present solution relate to display systems for use as wearable devices, or “wearables,” whether it be for both eyes or a single eye. In an embodiment, the wearable device comprises an optical subsystem having components including a light source and an exit module to produce at least a part of a virtual image. A mechanical actuator scans a component of the optical system, such that a virtual image that spans the area swept out by the component is formed.

### BRIEF DESCRIPTION OF THE DRAWINGS

FIG. 1 depicts the primary components of the methods and systems disclosed presently.

FIGS. 2A through 2D depict the optical, electrical, and mechanical subsystems and subassemblies comprising the primary components, to be integrated into a wearable solution.

FIGS. 3A through 3F depict a set of embodiments of the disclosed technology.

FIGS. 4A through 4C depict flow diagrams describing the operation, control, and calibration of the wearable.

FIGS. 5A through 5S depict a set of embodiments of source-separated wearable technologies.

FIGS. 6A through 6K depict a set of embodiments of source-adjacent wearable technologies.

FIGS. 7A and 7B present analyses of the wearable technologies, including optical reflectivity of the light exit module and scanning rates for the mechanical actuator and addressable components.

FIGS. 8A through 8G depict various scanning modes that produce virtual images from 1D exit modules.

FIGS. 9A through 9E depict embodiment geometries with multiple light exit modules for one or two eyes.

FIGS. 10A through 10G illustrate various wearing mechanisms that provide physical support of the wearable to the human body or to a wearable accessory.

FIGS. 11A through 11E depict collapsing or folding mechanisms to reduce the form factor of the wearable device for storage or better portability.

FIGS. 12A through 12H depict auxiliary embodiments of the wearable device using other mechanisms.

### DETAILED DESCRIPTION

The technology introduced herein has multiple uses and benefits. Wearable devices allow for portable multimedia consumption to assist with activities, enhance productivity, or improve entertainment experiences. A reduced form factor improves the physical comfort of the device, and true-depth imagery reduces or eliminates eye fatigue when viewing visual content. Depth effects include monocular depth effects and binocular depth effects. Below are embodiments of the solution to explain these uses and demonstrate other uses and effects in more detail.

In some embodiments, a wearable multimedia system comprises an optical subsystem having a light source and an exit module, the exit module coupled to the light source, a mechanical actuator to periodically scan a lateral position of the exit module along a primary direction, and a mechanical mount to attach the wearable multimedia system to a body part, wherein a virtual image is formed spanning a lateral area swept out by the exit module along the primary direction.

In some embodiments of the wearable multimedia system, the exit module and the light source are coupled by a flexible optical waveguide.

In some embodiments of the wearable multimedia system, the flexible optical waveguide is at least one optical fiber.

In some embodiments of the wearable multimedia system, the mechanical mount is selected from a group consisting of an earpiece support, a shoulder support, a neck support, a nose support, a head support, and combinations thereof.

In some embodiments of the wearable multimedia system, the exit module is formed at least in part by a side of the flexible optical waveguide and has a length of at least 0.5 cm.

In some embodiments of the wearable multimedia system, the exit module comprises a plurality of semi-reflectors and a plurality of electro-optic modulators to modulate the virtual image.

In some embodiments, the wearable multimedia system further comprises a plurality of mechanical joints such that the exit module, the light source, and the flexible optical waveguide are collapsible.

In some embodiments of the wearable multimedia system, the exit module comprises a plurality of Bragg gratings to outcouple the light.

In some embodiments, the wearable multimedia system further comprises an audio submodule.

In some embodiments of the wearable multimedia system, the light source is a 1D line source.

In some embodiments of the wearable multimedia system, the light source comprises three or fewer pixel sources.

In some embodiments, the wearable multimedia system further comprises a plurality of sensors and a computational module (i) to detect a property of an environment or of a user, and (ii) to impact the virtual image based on said property.

In some embodiments of the wearable multimedia system, the exit module comprises at least one waveguide to outcouple the light, the at least one waveguide modulated using a property selected from a group consisting of: an electrical modulation, a magnetic modulation, an optical modulation, a thermal modulation, a photochemical modulation, and combinations thereof.

In some embodiments, a wearable multimedia system comprises an optical subsystem having a light source and an exit module, the exit module coupled to the light source, a mechanical actuator to a geometry of the optical subsystem and a mechanical mount to connect the optical subsystem to the human body, wherein a virtual image is formed spanning an area swept out by the exit module.

In some embodiments of the wearable multimedia system, the exit module comprises a microlens array.

In some embodiments of the wearable multimedia system, the optical subsystem comprises a curved display.

In some embodiments of the wearable multimedia system, the mechanical actuator scans the geometry of the optical subsystem using a rotating motion.

In some embodiments, a wearable multimedia system, comprises an optical subsystem having a plurality of light sources and a plurality of exit modules, each exit module among the plurality of exit modules coupled to a respective light source among the plurality of light sources, a plurality of mechanical actuators to scan plurality of exit modules, and a mechanical mount to connect the optical subsystem to the human body, wherein at least one virtual image formed spanning a lateral area swept out by the plurality of exit modules.

In some embodiments of the wearable multimedia system, a first exit module among the plurality of exit modules produces a first virtual image for a first eye of a viewer, and a second exit module among the plurality of exit module produces a second virtual image for a second eye of the viewer, the first virtual image and the second virtual image having a monocular depth.

In some embodiments of the wearable multimedia system, the first virtual image and the virtual second image jointly have a stereoscopic depth equal to the monocular depth.

In some embodiments of the wearable multimedia system, a first exit module and a second exit module for a single contiguous virtual image visible by an eye of a viewer.

### Nomenclature

In this description, references to an “embodiment,” “one embodiment,” or similar words or phrases mean that the feature, function, structure, or characteristic being described is an example of the technique or invention introduced here. Occurrences of such phrases in this specification do not necessarily all refer to the same embodiment. On the other hand, the embodiments referred to herein also are not necessarily mutually exclusive. The invention here is explained relative to preferred embodiments, but it is to be understood that modifications or variations can be made without departing from the scope of the claimed invention.

All references to “user,” “users,” “observer,” “wearer,” or “viewer,” pertain to either an individual or individuals who would use the apparatus, methods, and techniques introduced here. A user interacts with a system using a sense, which could be visual, auditory, tactile, or olfactory. In some embodiments, the system is a display system, and the user or viewer is viewing the image content. A user may be a future or past user to allow for asynchronous applications.

The term “arbitrarily engineered” means being of any shape, size, material, feature, type or kind, orientation, location, quantity, components, and arrangement of single components or arrays of components that enables the present invention. Two elements are “optically coupled” when the first element being imparts, transfers, feeds, or directs light to the second element directly or indirectly. More generally, two elements are “coupled” when the first element being imparts, transfers, feeds, or directs energy or information to the second element directly or indirectly. The energy may be light, acoustic, thermal, electronic, mechanical, radio-frequency or other electromagnetic energy, and the like. The information includes any structure of the energy forming data.

A “wearable” or a “wearable system” is a system that a person may affix to his body or an accessory, like glasses, hats, clothing, and the like. A multimedia wearable system is a device that generates content for the wearer, for example, video and/or audio content. Thus, a multimedia wearable device is an example of a display system.

As used herein, the term “chief ray” refers to the central axis of a light cone that is emitted by a pixel source or a point-like source, or that is reflected by a point on an object.

“Monocular optical depth” or “monocular depth” is a perceived distance, or apparent depth, between the observer and the apparent position of an image. It equals the distance to which an eye accommodates (focuses) to see a clear image. Thus, the monocular depth is the accommodation depth corresponding to the accommodation depth cue. Each eye experiences this depth cue.

Monocular depths may be understood as follows. A point source of light emits light rays equally in all directions, and the tips of these light rays can be visualized as all lying on a spherical surface, called a wavefront, of expanding radius. In geometric optics in, for example, free space or isotropic media, the wavefront is identical the surface that is everywhere perpendicular to the light rays, and can be calculated by e.g., the eikonal equation, Lagrangian optics, Hamiltonian optics, and the like. When the point source is moved farther from an observer, emitted light rays travel a longer distance to reach the observer and therefore their tips lie on a spherical wavefront of larger radius and correspondingly smaller curvature, i.e., the wavefront is flatter. This flatter wavefront is focused by an eye differently than a less flat one. Thus, the point source is perceived by an eye or camera as a farther distance, or deeper depth, to the object. Monocular depth does not require both eyes, or stereopsis, to be perceived. An extended object can be considered as a collection of point sources at varying positions and as consequently emitting a wavefront corresponding to the sum of the point-source wavefronts, so the same principles apply to, e.g., an illuminated object or emissive display panel. Wavefront evolution refers to changes in wavefront curvature due to optical propagation.

A virtual image is produced by a virtual display system, which produces images at two or more perceived depths, or a perceived depth that is different from the depth of the display panel that generates the image. A virtual display system may be a free-standing system, like a computer monitor or television set. It may also be part of a cellphone, tablet, headset or wearable, smart watch, or any portable device. Multiple individuals may interact with each other through a virtual display system or a plurality of them. Virtual display systems may be volumetric or lightfield displays, holographic displays, (auto-)stereoscopic displays, multifocal displays, and the like.

The term “display content” is used to describe the source information or the final image information that is perceived by a viewer. It is essentially the information that is fed into the optical subsystem of a device.

An “eyebox” is the volume of space wherein a human eye may be located to view an image. In some embodiments, the virtual display system produces an eyebox whose volume is big enough to encompass both eyes of a viewer simultaneously. In such cases, the eyebox is alternatively called a “headbox.” In some embodiments, the headbox is a continuous headbox and is larger than the average interpupillary distance for a person, such that both eyes can be located within the headbox simultaneously. The virtual images in these embodiments are simultaneously visible by both eyes of a view. In some embodiments the headbox is large enough for a plurality of viewers to see a virtual image. In another embodiment, the virtual display system produces a left eyebox and a right eyebox, configured for simultaneous viewing by the left and the right eye, respectively. The size and number of eyeboxes depends on the specific nature and design of the display.

When a continuous headbox is big enough to encompass both eyes of a viewer, each point of the virtual image is visible by both eyes of the viewer, i.e., light rays from any given point of the virtual image enter both eyes simultaneously. To receive the virtual image, the viewer's eyes may be located anywhere within the headbox, which spans a lateral dimension. The lateral dimension may be, for example, at least 8 cm, at least 10 cm, at least 15 cm, at least 20 cm, or at least 30 cm. The distance between the display system and the nearest viewing position in the headbox may be, for example, between at least 30 and 60 cm, greater than 20 cm, or less than 100 cm. This distance is in part limited by the viewing direction required to see the virtual image.

In some embodiments, the virtual image has a lateral size of at least 1 cm, at least 2 cm, at least 3 cm, at least 5 cm, or at least 10 cm.

Display systems may incorporate any hardware, including liquid crystals or other polarization-dependent elements to impact properties of the display; any type of mirror or lens to redirect the light path, influence the size in any dimension, modify the focal depth, or correct for aberrations and distortions; any surface coatings, active elements; spectral or spatial filters to assist in image quality; optical cavities; or any type of element or coating to serve as a shield layer or antireflection layer to reduce unwanted, stray, or ambient light from reaching a viewer. In some embodiments, display systems comprise metamaterials and metasurfaces, nonlinear optical elements, photonic crystals, graded-index materials, anisotropic or bi-anisotropic elements, or electro-optic elements. In some embodiments, display systems are virtual display systems. Further, display systems can operate in any part of the electromagnetic spectrum, including visible, infrared (IR), mid-IR, near-IR, far-IR, ultraviolet (UV), terahertz (THz), or radiofrequency (RF). A display system may use a curved display panel in some embodiments.

A display system can produce images, overlay annotations on existing images, feed one set of display content back into another set for an interactive environment, or adjust to environmental surroundings. Users may have VR, AR, MR, or XR experiences; video-see through effects; monitor remote systems and receive simultaneous predictive suggestions; provide an avatar with permissions to make imprints on digital content or online resources; or use AI for generative content creation. A subsection of the display content may be input into an algorithm to impact another subsection.

A “subsection” of display content is a partitioning of the display content produced by the display system. In some embodiments, a subsection is a pixel or set of pixels. The set of pixels may be disjoint or contiguous. In some embodiments, a subsection corresponds to a feature type of the display content. For example, a subsection of an image of a person may be a head or an arm, and another subsection may be a hand or an eye. In some embodiments, a subsection may be an entire layer or part of a layer or focal plane of a display that produces multiple focal planes. In some embodiments, a subsection is a part of the spectral content of an image or a portion of the image in an arbitrary mathematical basis. Subsections may also be partitioned differently at various times. In some embodiments, a subsection is one of the segments of a segmented display.

As used herein, the “display aperture,” “exit aperture,” and the like is the surface where the light exits the display system toward the exit pupil of the display system. The aperture is a physical surface, whereas the exit pupil is an imaginary surface that may or may not be superimposed on the aperture. After the exit pupil, the light enters the outside world.

As used herein, the “imaging aperture” is the area or surface where the light enters an imaging system after the entrance pupil of the imaging system and propagates toward the sensor. The entrance pupil is an imaginary surface or plane where the light first enters the imaging system.

“Image aperture optic,” “aperture optic,” “exit aperture optics,” and the like correspond interchangeably to a set of optical elements located at the display aperture surface. In some embodiments, the set contains only one element, such as a transparent window. Exit aperture optics protect the inside of the display system from external contaminants. Exit aperture optics are also used to prevent unwanted light from entering the display system. In a display system, “stray light” is unwanted light that interacts with the display system and travels along a substantially similar path as the desired image into a viewer's eyes. E.g., stray light includes ambient light that enters the system through an undesired entrance and finally exits through the display aperture to be visible by an observer, thus degrading the viewing experience. With exit aperture optics, such stray light prevents or mitigates this degradation by removing stray light or its effects. In some embodiments, exit aperture optics includes a wave plate and a polarizer. In some embodiments, it includes an antireflection coating. In the context of stray light mitigation, an exit aperture may also be called an “ambient light suppressor.”

In some embodiments, the exit aperture optics is configured to direct as much light as possible to a viewer and may include diffractive optic elements, Fresnel lens or surfaces, nanocone or nanopillar arrays, antireflection layers, and the like.

The terms “field evolving cavity” or “FEC” refer to a non-resonant (e.g., unstable) cavity, comprising reflectors or semi-reflectors, that allows light to travel back and forth between those reflectors or semi-reflectors to evolve the shape of the wavefront, and consequently the monocular depth, associated with the light in a physical space. One example of an FEC may comprise two or more half-mirrors or semi-transparent mirrors, facing each other and separated by an air gap or dielectric of distance d. The light that travels from the first half-mirror, reflected by the second half-mirror, reflected by the first half-mirror, and finally transmitted by the second half-mirror will have traveled a total distance of 2d, which is the monocular depth. Thus, the monocular depth is larger than the length of the FEC. If, for example, the source of light is a pixel, which is approximately a point source, the FEC causes the spherical wavefront of the pixel to be flatter than it would be if the light traveled once through the gap.

In some embodiments, an FEC may be parallel to or optically coupled to a display or entrance aperture optics (in the case of display systems that use ambient light as the light source) or to an imaging aperture or imaging aperture (in the case of imaging systems). In some embodiments, an FEC changes the apparent depth of a display or of a section of the display.

As another non-limiting example, an FEC comprises a reflector and a semi-reflector oriented at an angle to the reflector. The semi-reflector receives and reflects light from a light source and directs it toward the reflector. The reflector receives said light, then reflects it toward the semi-reflector, which (partially) transmits the light to the outside world, towards a viewer. In an FEC, a round trip occurs once the light completes one cycle and comes back to the first (semi-)reflective component.

In some embodiments, a “round trip” occurs when light substantially reverses direction to interact with an element of an optical system more than once. The term “round trips” denotes the number of times that light circulates or bounces back and forth between two cavity elements, or the number of times light interacts with a single element.

FECs can have infinitely many different architectures, but the principle is always the same. An FEC is an optical architecture that creates multiple paths for the light to travel, either by forcing the light to make multiple round trips or by forcing the light from different sections of the same display (e.g., a segmented display) to travel different distances before the light exits the cavity. If the light exits the cavity perpendicular to the angle it has entered the cavity, the FEC is referred to as an off-axis FEC or a “FEC with perpendicular emission.”

An FEC assists in providing depth cues for three-dimensional perception for a user. In some embodiments, a depth cue is a monocular depth cue. The number of round trips is arbitrarily engineered. For example, there may be 0, 1, 2, or 3 round trips. The number of round trips substantially determines the monocular depth perceived be a viewer. In some embodiments, a monocular depth is larger than the distance between the viewer and the light source. For example, the ratio between the monocular depth and the distance may be at least 1, at least 1.1, at least 1.5, at least 2, at least 2.5, at least 3, at least 4.5, or at least 5. In some embodiments, the ratio may lie within a range across the virtual image, such as between 1 and 2, between 1 and 4, between 2 and 4, or greater than 2. In some embodiments, a monocular depth is dynamically adjustable by modifying a property of the virtual display system.

In some embodiments, polarization-dependent and polarization impact elements—such as polarizers, wave plates, and polarizing beam splitters—may be used to increase the light efficiency or modify the number of round trips. In some embodiments, different light rays travel different total distances to produce multiple focal planes, or a multi-focal image, which has a plurality of image depths. In some embodiments, an image depth is dynamic or tunable via, e.g., electro-optic structures that modify the number of round trips.

The “light efficiency” or “optical efficiency” is the ratio of the light energy the reaches the viewer to the light energy emitted by an initial display.

Throughout this disclosure, “angular profiling” is the engineering of light rays to travel in specified directions. Angular profiling may be achieved by directional films, holographic optical elements (HOEs), diffractive optical elements (DOEs), lenses, lenslet arrays, microlens arrays, aperture arrays, optical phase masks or amplitude masks, digital mirror devices (DMDs), spatial light modulators (SLMs), metasurfaces, diffraction gratings, interferometric films, privacy films, or other methods. “Intensity profiling” is the engineering of light rays to have specified values of brightness. It may be achieved by absorptive or reflective polarizers, absorptive coatings, gradient coatings, or other methods. The color or “wavelength profiling” is the engineering of light rays to have specified colors, or wavelengths. It may be achieved by color filters, absorptive notch filters, interference thin films, or other methods. “Polarization profiling” is the engineering of light rays to have specified polarizations. It might be achieved by metasurfaces with metallic or dielectric materials, micro- or nanostructures, wire grids or other reflective polarizers, absorptive polarizers, quarter-wave plates, half-wave plates, 1/x waveplates, or other nonlinear crystals with an anisotropy, or spatially profiled waveplates. All such components can be arbitrarily engineered to deliver the desired profile.

“Distortion compensation” is a technique for compensating errors in an optical system that would otherwise degrade image quality. In some embodiments, the distortion compensation is computational. The desired image content is pre-distorted such that when it experiences a physical distortion, the effect is negated, and the result is a clear image. Distortions to compensate include aberrations, angular variations of reflections. For example, a birefringent or anisotropic element may be added to account for an angle-dependent response of a wave plate. Such elements are called compensators or C-plates, A-plate, or O-plates. Some such elements are biaxial films. Distortion compensation may also be affected computationally. For example, if a virtual display system produces a barrel distortion, a pre-computed image may include a pincushion-type distortion, such that the net effect is an image with minimal or zero barrel or pincushion distortion. Another type of distortion correction is perspective distortion correction. Other types of distortion compensation include perspective distortion compensation, which pre-compensates skewed based on off-axis reflections of optical elements. This can be pre-compensated using a homography transformation, keystone correction, and the like.

For example, the virtual image may have a barrel distortion that is produced by the nonuniform magnification of different elements of the image as they travel through a field-evolving cavity. The barrel distortion may be modeled as a function that transforms the image according to a polynomial function, such as ƒ(r)=r(1−kr²), where r is the radial distance from the center of the image, and k is a system parameter. To pre-compensate this barrel, distortion, the inverse function g may be applied to the display content itself, where g(r)=r/(1−kr²). To apply this to the image, an algorithm may determine the pixel size of the display content, calculate the center pixel, create a matrix of the same pixel size of the image, and use g(r) to map each pixel value of the original display content to an element in the matrix. The radial distance is calculated by calculating the pixel distance between the pixel to be mapped and the center pixel. When all the pixels have been mapped, the matrix then becomes the new display content that is pre-compensated. The actual functions ƒ and g depend on the specific configuration and shapes of the optics elements in the display system. Other types of compensation algorithms may use an inverse function, look-up table, machine learning algorithm, or neural network. In some embodiments, the pre-compensation may affect the intensities of the pixels or the color profile.

In this document, the terms “machine readable medium,” “computer readable medium,” and similar terms are used to refer to non-transitory mediums, volatile or non-volatile, that store data and/or instructions that cause a machine to operate in a specific fashion. Common forms of machine-readable media include, for example, a hard disk, solid state drive (SSD), magnetic tape, or any other magnetic data storage medium, an optical disc or any other optical data storage medium, any physical medium with patterns of holes, a random access memory (RAM), a programmable read-only memory (PROM), erasable programmable read-only memory (EPROM), a FLASH-EPROM, non-volatile random access memory (NVRAM), any other memory chip or cartridge, and networked versions of the same.

These and other various forms of computer readable media may be involved in carrying one or more sequences of one or more instructions to a processing device for execution. Such instructions embodied on the medium, are generally referred to as “instructions” or “code.” Instructions may be grouped in the form of computer programs or other groupings. When executed, such instructions may enable a processing device to perform features or functions of the present application as discussed herein.

A “processing device” may be implemented as a single processor that performs processing operations or a combination of specialized and/or general-purpose processors that perform processing operations. A processing device may include a central processing unit (CPU), graphics processor unit (GPU), accelerated processing unit (APU), digital signal processor (DSP), field programmable gate array (FPGA), application specific integrated circuit (ASIC), system on a chip (SOC), and/or other processing circuitry.

AI is any intelligent operation produced by a machine. Intelligent operations include perception, detection, scene understanding, generating, or perceiving information, or making inferences. The terms “neural network,” “artificial neural network,” or “neural net” refer to a computational software architecture that are example implementations of AI and that is capable of learning patterns from several data sources and types and making predictions on data that it has not seen before. The types, algorithms, or architectures, of neural networks include feedforward neural networks, recurrent neural networks (RNN), residual neural networks, generative adversarial networks (GANs), modular neural networks, or convolutional neural networks (CNN) (used for object detection and recognition). Neural networks can comprise combinations of different types of neural network architectures. The parameters of a neural network may be determined or trained using training data. Neural networks can be supervised or unsupervised. The learning can be completed through optimization of a cost function. In some embodiments, the neural network architecture is a radial basis network, multi-layer perceptron architecture, long-short term memory (LSTM), Hopfield network, or a Boltzmann machine. Neural network architectures can be one-to-one, one-to-many, many-to-one, many-to-many. Any of the AI algorithms can be used in the AI-based embodiments in this disclosure. For example, a GAN may use an optimization by stochastic gradient descent to minimize a loss function. An LSTM or RNN may use a gradient descent algorithm with backpropagation.

A “transformer” is a machine learning model in deep learning that relies on self-attention to weigh input data in diverse ways. Transformers are often used in computer vision and natural language processing (NLP). They differ from RNNs in that the input data is processed at once, rather than sequentially. Generative pre-trained transformers and bidirectional encoder representations from transformers are examples of transformer systems. Applications include video or image understanding, document summarization or generation, language translation, and the like.

Learning algorithms may be supervised or unsurprised. Some supervised learning algorithms used to implement the embodiments disclosed herein include decision trees or random forest, support vector machines, Bayesian algorithms, and logistic or linear regression. Unsupervised learning gains information by understanding patterns and trends in untagged data. Some algorithms include clustering, K-means clustering, and Gaussian mixture models. In some embodiments, non-neural network computational methods are used to generate display content. In some embodiments, neural networks are combined with other computational methods or algorithms. Other computational methods include optimization algorithms, brute force algorithms, randomized algorithms, and recursive algorithms. Algorithms can implement any mathematical operation or physical phenomena.

Some neural networks are zero-shot or few-shot. Some are teacher-student networks. In some embodiments, retrieval augmented generation is used. One-shot and zero-shot learning are advanced techniques in neural networks that enable models to recognize new classes with minimal or no training examples. One-shot learning, e.g., Siamese Neural Networks, can classify unseen classes using just a single example. Zero-shot learning, relies on semantic descriptions to classify entirely new categories without any training data.

Some networks are teacher-student networks, a form of knowledge distillation, transfer expertise from larger models to smaller, more efficient ones. This approach may be applied in various domains, including image classification on various datasets, as well as natural language processing tasks like machine translation and sentiment analysis.

In some embodiments, neural networks are enhanced by retrieval-augmented generation (RAG).

Some applications include image classification, object detection, facial recognition, image segmentation, and visual question answering. In some embodiments, semantic segmentation is performed. Some models or architectures include ResNet, YOLO, FaceNet, U-Net, Vision Transform, and the like. Other segmentation function algorithms include thresholding, region growing, clustering-based segmentation, watershed algorithm, graph-based segmentation, edge-based segmentation, active contour models (snakes), convolutional neural networks (CNNs), Markov-random fields (MRFs), level set methods, and the like.

All such components and software can be arbitrarily engineered to deliver the desired profile. As used herein, “arbitrary optical parameter variation” refers to variations, changes, modulations, programing, and/or control of parameters, which can be one or a collection of the following variations: bandwidth, channel capacity, brightness, focal plane depth, parallax, permission level, sensor or camera sensitivity, frequency range, polarization, data rate, geometry or orientation, sequence or timing arrangement, runtime, or other physical or computational properties. Further parameters include optical zoom change, aperture size or brightness variation, focus variation, aberration variation, focal length variation, time-of-flight or phase variation (in the case of an imaging system with a time-sensitive or phase-sensitive imaging sensor), color or spectral variation (in the case of a spectrum-sensitive sensor), angular variation of the captured image, variation in depth of field, variation of depth of focus, variation of coma, or variation of stereopsis baseline (in the case of stereoscopic acquisition).

The “optic axis” or “optical axis” of a display (imaging) system is an imaginary line between the light source and the viewer (sensor) that is perpendicular to the surface of the aperture or image plane. It corresponds to the path of least geometric deviation of a light ray.

A “thin film” is a subwavelength-thick film or layer. Multilayer films comprise multiple thin films. Some films may be birefringent. In some embodiments, one or more layers are switchable, such as an LC thin film. Thin films and multilayer films may be coated onto solid substrates or other optical components.

As used herein, “imaging system” refers to any apparatus that captures an image, which is a matrix of information about light intensity, phase, temporal character, spectral character, polarization, entanglement, or other properties used in any application or framework. Imaging systems include cellphone cameras, industrial cameras, photography or videography cameras, microscopes, telescopes, spectrometers, time-of-flight cameras, ultrafast cameras, thermal cameras, or any other type of imaging system. In some embodiments, the gesture that is output can be used to execute a command in a computer system connected, wireless or by hardwire, to the gesture camera.

Some capabilities described herein may be implemented in one or more modules. A module comprises the hardware and/or software, to implement the capability. For example, such a capability may be implemented through a module having one or more processors executing computer code stored on one or more non-transitory computer-readable storage medium. In some embodiments, a capability is implemented at least in part through a module having dedicated hardware (e.g., an ASIC, an FPGA). In some embodiments modules may share components. For example, a first function module and a second function module may both utilize a common processor (e.g., through time-share or multithreading) or have computer executable code stored on a common computer storage medium (e.g., at different memory locations).

In some instances, a module may be identified as a hardware module or a software module. A hardware module includes or shares the hardware for implementing the capability of the module. A hardware module may include software, that is, it may include a software module. A software module comprises information that may be stored, for example, on a non-transitory computer-readable storage medium. In some embodiments, the information may comprise instructions executable by one or more processors. In some embodiments, the information may be used at least in part to configure hardware such as an FPGA. In some embodiments, the information for implementing capabilities such as functions, visual templates, graphical user interfaces, input stream reception, and input stream generation may be recorded as a software module. The capability may be implemented, for example, by reading the software module from a storage medium and executing it with one or more processors, or by reading the software module from a storage medium and using the information to configure hardware.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in numerous ways. Different combinations and sub-combinations are intended to fall within the scope of this disclosure, and certain method or process blocks may be omitted in some implementations. Additionally, unless the context dictates otherwise, the methods and processes described herein are also not limited to any sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computers processors, not only residing within a single machine but deployed across several machines.

Further, the methods in this disclosure can be used in arbitrarily engineered imaging systems, including, but not limited to, microscopes, endoscopes, hyperspectral imaging systems, time-of-flight imaging systems, telescopes, remote imaging systems, scientific imaging systems, spectrometers, and satellite imagery cameras.

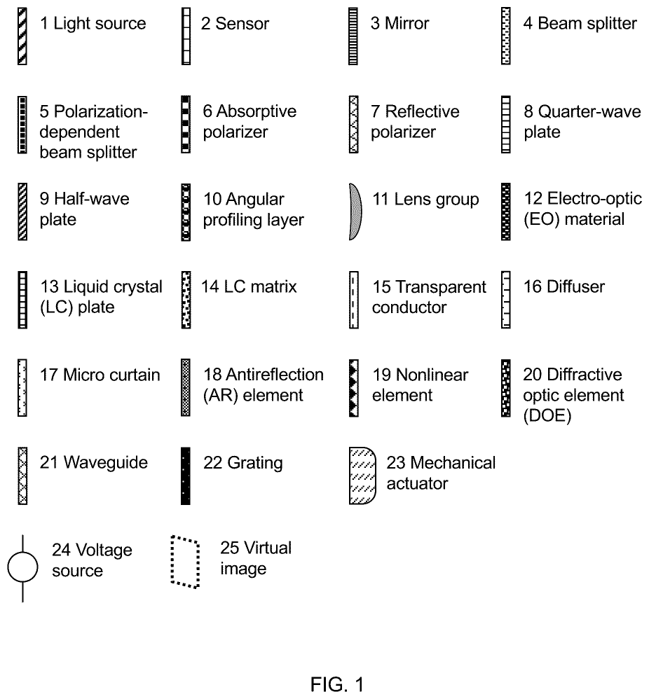

FIG. 1 depicts a set of elements that represent the fundamental components and structures of the embodiments disclosed herein.

A light source 1 is any component or structure that emits light. In the following embodiments, the light generated by the light source collectively forms an image. Usually, the light source includes driving electronics to vary the emitted light in time or heat dissipation elements to maintain adequate temperatures. The light source may provide a virtual image that provides stereoscopic depth with or without glasses, or that provides monocular depth. The display may be used in a wearable display, like near-eye display for a headset, or it may be used in far-standing display, which is stationary during use.

Examples of light sources include one or more lasers, one or more light emitting diodes (LEDs), one or more micro LEDs, one or more quantum dot elements or other photoluminescent elements, a backlight of any variety (e.g., electroluminescent, fiber optic bundles coupled to an LED, or cold cathode fluorescent lamp), a display panel, and the like. The intensity, polarization, luminance, angular profile, and spectrum can be arbitrarily engineered. Other light source technologies include likes liquid crystal (LC) sources, thin-film transistor (TFT), light emitting diode (LED), organic light emitting diodes (OLEDs), active matrix organic light emitting diode (AMOLEDs), micro LED, plastic organic light emitting diode (POLED), micro organic light emitting diode (MOLED), or projection or angular-projection arrays on flat screens or angle-dependent diffusive screens or any other display technology and/or mirrors and/or half-mirrors and/or switchable mirrors or liquid crystal sheets arranged and assembled in such a way as to exit bundles of light with a divergence apex at different depths or one depth from the core plane or waveguide-based displays.

In some embodiments, its properties change during its operation. For example, a laser beam scanner is a light source whose beam direction changes in time. In some embodiments, the emitted light is an optical system to impact another component or structure, for example, as in a nonlinear or photo-activated interaction.

The geometry of the light source is arbitrarily engineered. They may be approximated as point sources, be extended, flat, curved, or bend; comprise smaller light sources tiled together.

The spectrum of a display is arbitrarily engineered. For conventional images or virtual display systems, the display panels usually emit white light, which contains enough spectral components (e.g., red, blue, and green) such that the image is perceived as a white-light image or a full-color image.

In some embodiments, a light source is a single pixel source, e.g., a single point-like source of light, like a single LED or a single laser. The angular profile may be Lambertian, collimated, arbitrarily engineered to have side lobes, and the like. In some embodiments, there are multiple single pixel sources, for example, 2, 3, 4, 5, 6, 7, 8, or 9 single pixel sources. For example, a light source may comprise three single pixel sources corresponding to red (R), green (G), and blue (B) light. In some embodiments, the light source is a line display, i.e., it has many pixels along a primary direction, but 1 or only a few in the orthogonal direction. For example, such a light source may have 1×N pixels, where N maybe be more than 50, more than 100, more than 500, or more than 1000. In some embodiments, the light source is M×N pixels, where MIN<<1, e.g., MIN<0.1, <0.05, or <0.01. Such a source is called a 1D line source.

A “display system” is any device that produces images. Physical sources of display images can be standard 2D images or video, as produced by a display panel or a plurality of display panels. Such display technologies, or a plurality of them, may also be incorporated into other display systems. In some embodiments, spatial light modulators (SLMs) are used. In some display systems, light sources may be coupled with masks or patterned elements to make the light source segmented and addressable. Other sources may be generic light sources, such as one or several LEDs, backlights, or laser beams, configured for use, for example, in projection-based display systems. A display system may be a headset, a handheld device, or a free-standing system, where the term “free-standing” means that the device housing can rest on a structure, such as a table. In some embodiments, the display system is configured to be attached to a structure by a mechanical arm.

In some embodiments, the light source includes a luminescent material that emits light. In some embodiments, the luminescence is phosphorescence, or it is fluorescence, which are “photoluminescent” materials. Luminescent materials' light emission may be caused by the absorption of light, usually at a different wavelength. In some embodiments, there is IR to visible up conversion. In some embodiments, the fluorescent particles comprise quantum dots, such as CdS. In some embodiments the photoluminescent materials are activated, switched, or otherwise modified by another light source. A “quantum dot” (QD), or “quantum-dot layer,” is a fluorescent particle light source, or an element containing a plurality of such light sources, which are based on the absorption and emission of light from nanoparticles in which the emission process is dominated by quantum mechanical effects. These particles are a few nanometers in size, and they are often made of, but not limited to, II-IV semiconductor materials, such as cadmium sulfide (CdS), cadmium telluride (CdTe), indium arsenide (InAs), or indium phosphide (InP). When excited by ultraviolet light, an electron in the quantum dot is excited from its valence band to its conduction band and then re-emits light as it falls to the lower energy level. In some embodiments, QD spectra are modified by structure, morphology, temperature, strain.

Other luminescent materials or elements may be photoactivated or photoswitchable, which is activated to absorb light at a first wavelength and emit it at a second wavelength only in the presence of a third wavelength. Photoswitchable and photoactivated materials include fluorescent proteins such as PA-GFP, PAmKate, Denddra2, Kaede, EosFP, Dronpa, Kindling FP, and the like. The absorption, emission, and activation spectra can be arbitrarily engineered. Further examples include azobenzenes, spiropyrans, and diarylethenes, as well as donor-acceptor Stenhouse adducts, phototropic organic metals or metal oxides, some QDs, perovskites, and some ruthenium, iron, or cobalt complexes.

A sensor 2 is any transducer, array of transducers, or plurality of transducers that accepts information from the outside world and feeds that information into an apparatus. Sensors can be passive or active. In some embodiments, active sensors emit a signal, detect a return signal, and provide information based on differentiating features between the emission and the return. For example, an ultrasonic sensor, or generic time of flight sensor, calculates the distance to an object. In some embodiments, a sensor is an audio sensor such as a microphone. In some embodiments, the microphone is an optical microphone. User input devices such as keyboard, mouse, and the like are sensors for purpose of this disclosure.

In some embodiments, the sensor is an optical sensor that detects variations in ambient light intensity. Therefore, a sensor also includes any type of single- or multi-pixel sensors, camera, camera system, or camera array. For example, a camera may be a standard grayscale or color, e.g., RBG, camera, an infrared camera, a depth camera, a stereo camera, and the like.

In some embodiments a sensor or a plurality of sensors detects the geometry of a human, including the viewer of the display system. This includes, for example, detecting an eye gaze, eye position or orientation, or head position orientation. The resulting geometric information may be used to modify the image content. For example, in a display system that produces stereoscopic effects, the image may be based on the left and right eye position to maintain stereoscopic depth cues. As another example, an optical sensor may also be an infrared (IR) sensor, configured, for example, to detect hand motions or perform head/eye tracking. In some embodiments, a sensor detects a property of the environment, including motion of the user, atmospheric effects (like wind or turbulence), or ambient light levels.

Display content may be manipulated by a user or interactive with a user through various sensors or input devices. Input devices are types of sensors that take in a user input, usually deliberately rather than automatically. Input devices, such as keyboard and mouse input, touch screens, gesture sensors, head tracking, eye tracking, VR paddles, sound input, speech detection, allow for user feedback in multiple modalities. In some embodiments, various biological or health sensors capture information—such as heart rate, posture, seating or standing orientation, blood pressure, eye gaze or focus—and use that information in an algorithm to influence or impact the displayed content.

A mirror 3 is a specular reflector that reflects light with high reflectivity. Mirrors may be curved, flat, or free-formed to an arbitrary geometry shape. A mirror may alternatively be called a “reflector.” In some embodiments, the reflectivity of the mirror is due to a surface effect, such as a metallic coating or metal surface. The reflectance may be impacted by micro or nanostructures produced on the physical element. In some embodiments, the reflectivity is due to a bulk effect or to the joint effect of multilayer films. For example, a dielectric stack of thin films functions as a mirror in some embodiments. In some embodiments the mirror is switchable and may be turned on and off by an electric, optical, thermal, or mechanical/acoustic signal.

A beam splitter 4 is a specular reflector that partially reflects and partially transmits incident light. The ratio of reflected light to transmitted light can be arbitrarily engineered. In some embodiments, the transmission-to-reflection ratio is 50:50. In some embodiments, the transmission-to-reflection ratio is 70:30. A beam splitter is a semi-reflective layer that reflects a certain desired percentage of the intensity and transmits the rest of the intensity. A simple example of a beam splitter is a glass plate with a semi-transparent silver coating or dielectric coating on it, such that it allows 50% of the light to pass through it and reflects the other 50%. The term “semi-reflector” is used interchangeably with beam splitter.

Generally, both mirrors and beam splitters are used to direct light along a proscribed path in a display system. Both rely on specular reflection because their surfaces are smooth on the order of a wavelength. The term “specular reflector” therefore refers to both mirrors and beam splitters. The main difference is only the relative amount of light that is reflected. For example, with a perfect mirror, all the light is reflected, whereas in a standard beam splitter, about half the light is reflected. Though, a beam splitter may be designed to reflect other fractions of the light such as, for example, about 25% or 75%, or about 20% or 80%, or about 30% or 70%. How much light is reflected, the reflectance, may also vary depending on the incident wavelength or polarization.

Specular reflectors may be made of glass or metallic materials. In some embodiments specular reflectors are free of metallic materials. A non-limiting set of materials for a specular reflector includes include ion-exchanged glass, glass with or without silica coating (silicon dioxide) for mechanical protection, plastics such as acrylic, polycarbonate, PVC, PET, carbon-fiber-based plastics, non-magnetic ceramic materials, silicon carbine, polydimethylsiloxane (PDMS), stretched polyester films like Mylar®, or other polymer-type materials such as polyethylene terephthalate. Some optical elements comprise thin films or multilayer films, also called multilayer stacks. In some embodiments, reflective coating layers may include magnesium fluoride (MgF₂), tantalum pentoxide (Ta₂O₅), titanium dioxide (TiO₂), polymer materials, graphite, or other non-magnetic dielectrics. In some embodiments, a reflector is a transparent thin film that has etched (via laser means, chemical means, embossing means, and the like) to create microstructures for a DOE, holographic element, metasurface, grating or waveguide structure, and the like. In some embodiments, the optical components have gelatin or other flexible materials, such as hydrogels or similar polymers.

A polarization-dependent beam splitter (PBS) 5 reflects light of one polarization and transmits light of the orthogonal polarization. A PBS can be arbitrarily engineered and made using reflective polymer stacks, nanowire grids, or thin-film technologies. Other PBSs include PBS cubes. In some embodiments, a PBS is interchangeable with a reflective polarizer.

A “polarizer” is an optical component that filters the light based on its polarization. For example, a polarizer may transmit a certain polarization and not transmit the orthogonal polarization. In some embodiments, the transmitted light is linearly polarized at one angle, and the rejected light is linear polarized at a right angle to the first. In some embodiments, the transmitted polarization is left-(right-)circular polarization, and the rejected light is right- (left-)circular polarized. An absorptive polarizer 6 transmits light polarized along its pass angle and absorbs cross-polarized light. In some embodiments, the absorptive polarizer is made from dichroic materials like crystals. Polarizing materials include polyvinyl alcohol (PVA), iodine as a dopant, metallic nanoparticles like sub-500-um silver particles, and the like. A reflective polarizer 7 transmits light of a first polarization and reflects the orthogonal polarized light. A wire grid polarizer (a reflective polarizer made with nano wires aligned in parallel) is an example of a linear reflective polarizer. The reflectivity and transmittivity depends on the angle of the incident light. In some embodiments, a reflective polarizer may be substituted for a polarization-dependent beam slitter and vice versa.

A “wave plate” is a polarization-changing element that modifies the polarization of the light incident on it and operate under the principle of birefringence. Wave plates may comprise birefringent crystals, quartz, calcite, sapphire (Al₂O₃), magnesium fluoride (MgF₂), mica, plastic, various birefringent polymers. In some embodiments, a wave plate is a zero-order wave plate or an achromatic wave plate, or it may comprise multiple wave plates that function in different parts of the optical spectrum A quarter-wave plate (QWP) 8 is a wave plate that produces a relative phase shift of 90 degrees. It transforms linearly polarized light into circularly polarized light, and it transforms circularly polarized light into linearly polarized light. Similarly, a half-wave plate (HWP) 9 is a wave plate that produces a relative phase shift of 180 degrees between perpendicular polarization components that propagate through it. For linearly polarized light, the effect is to rotate the polarization direction by an amount equal to twice the angle between the initial polarization direction and the axis of the waveplate. In some embodiments, horizontally polarized light is converted to vertically polarized light, and vice versa, after transmission through an HWP.

An angular profiling layer 10 is an arbitrarily engineered layer to produce a specified angular distribution of light rays. In some embodiments, it allows the transmission of rays within a certain range of incident angles, whereas rays outside such a range of angles are blocked. In some embodiments an angular profiling layer is a directional film or layer. This element selectively transmits light rays that are oriented at angles within a specified angular range and blocks light rays directed outside that range. For example, the directional film may transmit light rays that are incident within a range from zero to 10 degrees, zero to 20 degrees, zero to 30 degrees, zero to 40 degrees, zero to 50 degrees, or zero to 60 degrees. In some embodiments, the directional film tilts the chief ray of the light source. The directional film does not provide optical (focusing) power. In some embodiments, the directional film transmits an angular range that does not start at zero degrees. A directional film may be placed after a light source. In some embodiments, the angular profiling layer functions along a single plane (e.g., the horizontal direction), whereas in other embodiments, it functions along more than one plane (e.g., the horizontal and vertical directions).

Some angular profiling layers provide optical power, or refraction. Another angular profiling layer example is a lenslet array. The lenslet array may be used in conjunction with a directional film to help focus or collimate the light. The lenselt array may be a microlens array. Each lenslet may be approximately the size, or smaller, than a pixel of a display.

A lens group 11, which consists of one or multiple lenses of arbitrary focal length, concavity, and orientation. In some embodiments, a lens group forms a real image on an imaging sensor. In some embodiments, a Fresnel lens is used. In some embodiments, the lens is a metasurface. A property of the lens, such as its focal length, may be tunable using, e.g., active or electro-optic materials like liquid crystals.

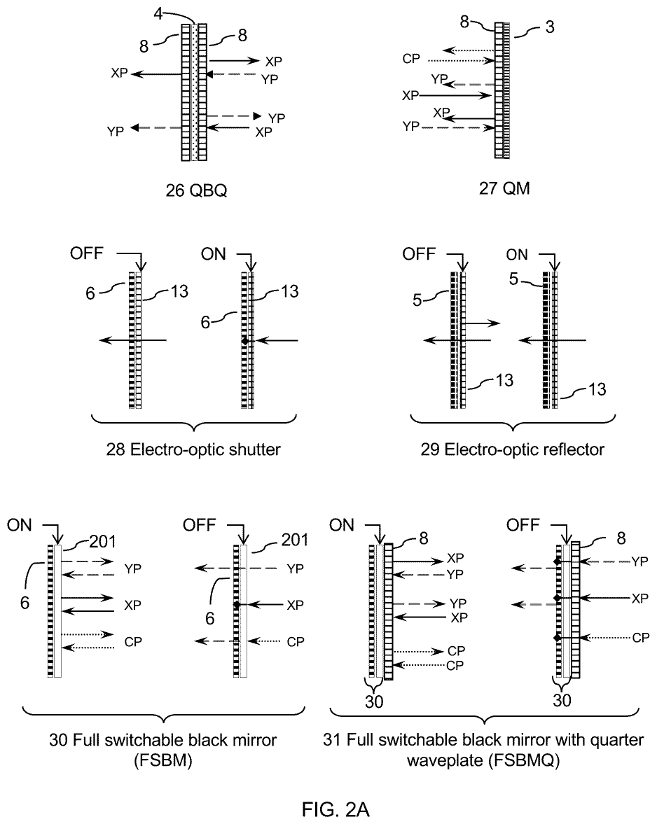

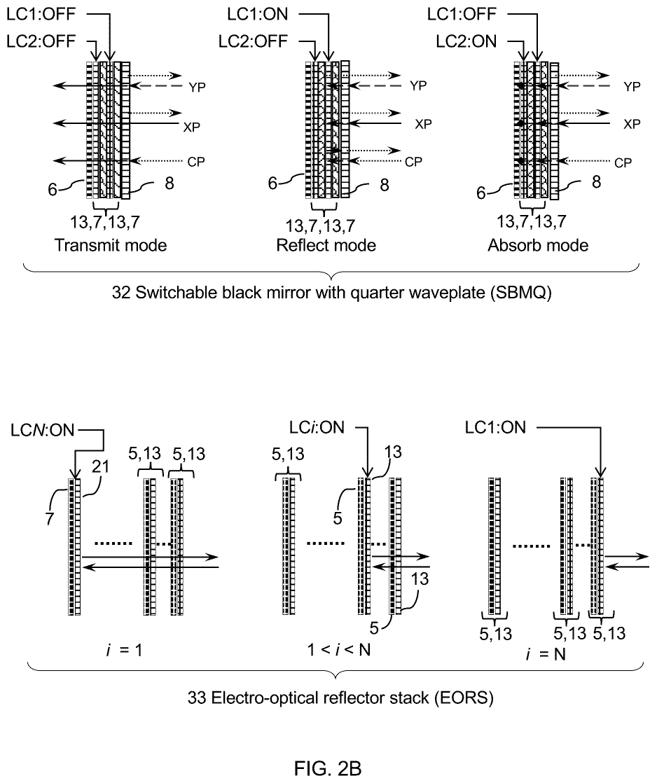

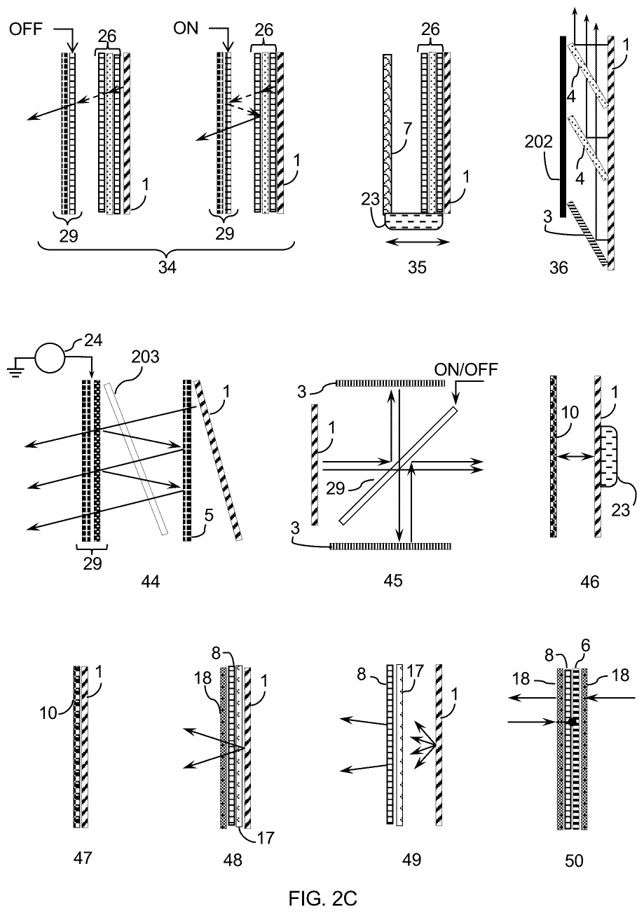

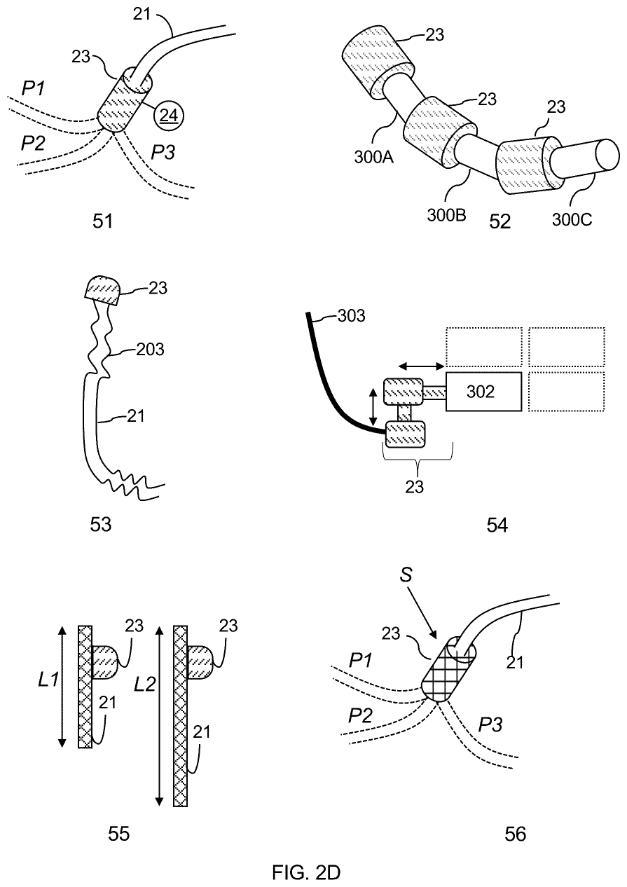

An electro-optic (EO) material 12 is a material whose refractive index changes with the application of an electric field. It is an example of a nonlinear element because the electric field may be caused incident light, which can experience that index change or cause a different light source to experience it. A photorefractive material is an example of an electro-optic material. When the field is caused by an external applied voltage, it is an active element. Throughout this disclosure, the terms “active design,” “active components,” or, generally, “active” refer to a design or a component that has variable optical properties that can be changed with an optical, electrical, magnetic, or acoustic signal. Electro-optical (EO) materials include liquid crystals (LC); liquid crystal as variable retarder (LCVR); or piezoelectric materials/layers exhibiting Pockel's effects (also known as electro-optical refractive index variation), such as lithium niobate (LiNbO₃), lithium tantalate (LiTaO₃), potassium titanyl phosphate (KTP), strontium barium niobate (SBN), and β-barium borate (BBO), with transparent electrodes on both sides to introduce electric fields to change the refractive index. The EO material can be arbitrarily engineered. Conversely, “passive designs” or “passive components” refer to designs that do not have any active component other than the display. EO materials include the EO-based subassemblies in FIGS. 2A and 2B. An EL material 6 may also be an EO rotator or an optically active material that rotates the polarization of the incident light by a specified amount.

An LC plate 13 is a uniform LC slab or thin film. In the “ON” state, the LC plate rotates the polarization of the light that passes through it. In the “OFF” state, the state of the light polarization is unchanged upon transmission through the layer. In some embodiments the LC is a nematic twisted crystal. In some embodiments, the LC plate is doped with other particles or elements, such as quantum dots, resonant nanoparticles, and the like. In some embodiments, the doped particles are fixed in place, such as conducting rods that extend from one side to the other. Such an architecture effectively provides conductivity to the LC and allows current to pass through it. In some embodiments the LCs are slightly conducting. In some embodiments, either the programming layer or the modulation layer comprises a photorefractive or other EO materials. In some embodiments, the LC is dye-doped LC (methyl-red), but this may be too slow for certain applications. The LC may be of any type: ferroelectric, twisted nematic, cholesteric, and the like. In some embodiments, the material is an LC-PR hybrid material. In some embodiments, the LC is doped randomly with nanospheres, subwavelength structures, or other particles.

The LC material may be of any type: twisted nematic/cholesteric, ferroelectric, nematic, smectic, discotic, and the like, and combinations thereof. Its specific structure and orientational/geometric properties can be arbitrarily engineered to produce the desired electro-optic effect. In some embodiments, an LC plate comprises layers of individual LC plates stacked on top of each other.

A liquid crystal (LC) matrix 14 is an addressable matrix comprising an array of electrically addressable LC cells, or pixels. The pixels of the of the LC matrix modulate the polarization of the incident light, such that a subsequent polarizer converts the polarization changes to intensity changes to produce an image.

More generally, an “addressable matrix” or “pixel matrix” is a transmissive element divided into pixels that can be individually (e.g., electrically) controlled as being “ON,” to transmit light, or “OFF,” to prevent light from passing, such that a light source passing through can modulated to create an image. The examples of displays above include such matrix elements. Generally, a “modulation matrix” is an element that is segmented such that light traveling incident on different portions of the modulation matrix experience different optical properties of the modulation matrix, the different optical properties being controllable. Such a layer is used to imprint spatial information, such as an image, onto the light. A modulation matrix may be absorptive, reflective, transmissive, or emissive; and it may comprise electrophoretic, absorptive, fluorescent or phosphorescent, mechanical, birefringent, electrooptic materials. An addressable matrix is an example of a modulation matrix layer. In some embodiments the optical properties of each portion of a modulation matrix depend also on the incident light (e.g., for a photochromic-based modulation matrix).

An LC-based effects may be impacted by coupling the LC such as doping with functional particles, using metallic materials like metallic layers or nanorods for plasmonic resonances, and the like.

An addressable matrix may take on other forms. For example, it may comprise a suspended particle device (SPD) that absorbs or transmits light based on an applied AC current. The SPD in some embodiments comprises a polyiodide compound.

In some embodiments, an LC matrix is doped with a dichroic molecule and relies on the guest host effect for dynamic absorption In some embodiments, other materials dope the LC, such as azobenzene, anthraquinone, ion dopants, and the like, which may be engineered by solubility, order parameter, or layer number.

In some embodiments, an LC is doped with a nanoparticle or relies on resonance/plasmonic absorption effects, including metallic nanorods. In these cases, added solvents may mitigate destabilization, and the nanoparticles may have other particles adhered to their surface.

In some embodiments, an addressable LC matrix relies on circularly polarized light and cholesteric LCs, which act as a reflective polarizer. The pitch, pitch gradient, and number of layers are arbitrarily engineered. These embodiments rely on reflection to spatially modulate the image.

In some embodiments, the addressable matrix relies on scattering to spatially modulate the image or prevent unwanted light from reaching the eye. These include polymer LCs, such as polymer dispersed (stabilized) LCs. In some embodiments, scattering relies on hydrodynamic instabilities when the voltage applied to the LC reaches a certain threshold.

In some embodiments, the electronic voltages applied to LC elements are done so through a transparent conductor 15, which is a material that has simultaneously high optical transparency and good electrical conductivity. In some embodiments, a transparent conductor is a semiconducting material, which may be doped. For example, indium tin oxide (ITO) is a transparent conductor. Other transparent conductors include graphene, silver or cupper nanowires, carbon nanotubes, MoO₃, aluminum-or gallium-doped zinc oxide, and boron-doped diamond. Note that a transparent conductor may also be a transparent semiconductor.

A diffuser 16 scatters light in a random or semi-random way. A diffuser can be a micro-beaded element/array or have another microstructure. Diffusers may reflect scattered light or transmit scattered light. The angular profile of the light may be arbitrarily engineered. In some embodiments, light scattered by a diffuser follows a Lambertian profile. In some embodiments, the light scattered forms a narrower profile. In some embodiments, the diffuser is a holographic diffuser to further profile the intensity profile. Some diffusers may operate by using microbeads or similar particles in the material.

A micro-curtain 17 redirects light into specified directions or shields light from traveling in specified directions. A micro curtain can be made by embedding thin periodic absorptive layers in a polymer or glass substrate, or it can be made by fusing thin black coated glass and cutting cross-sectional slabs.

An antireflection (AR) element 18 eliminates reflections of light incident on its surface. A microstructure such as a nano-cone layer may be an AR element. In some embodiments an AR element is a thin-film coating.

A nonlinear element 19 is a material whose optical response is modified or impacted by light. Photorefractive elements are nonlinear. The nonlinear material is sometimes defined by the form of the nonlinearity, for example, a temporal or spatial nonlinearity, a Kerr-type, saturable-type, or higher-order nonlinearity. Nonlinear elements may be of different phases (e.g., solid, liquid, gas, plasma, and the like). Nonlinearities include harmonic generation, sum or frequency generation, rectification, and the like.

A diffractive optical element (DOE) 20 has a structure to produce diffractive effects. The DOE can be of any material and may be arbitrary engineered. In some embodiments, a DOE is a Fresnel lens.

A waveguide 21 is a structure to guide light along a direction. In some embodiments, a display is formed by optically coupling a light source, such as a backlight, to a waveguide. In some embodiments, the waveguide comprises multiple waveguides or is wavelength dependent.

A waveguide may be diffractive or reflective.

In some embodiments, a waveguide assists in collimating the light from a light source to impact the perceived depth of the resulting virtual image. In some embodiments, a waveguide combines the light from the light source with light from the environment world to enable see-through AR effects. In some embodiments, the waveguide expands the exit pupil by replicated the light from the light source multiple times to increase the eyebox. A waveguide may have an in-coupling element to collect light from a light source, an out-coupling element to transmit light to an exit module and/or aperture optic—in some cases, the out-coupling requires the waveguide to change the angle of the light rays to be able to exit—and a splitting element to increase the eyebox. In some embodiments, these functions are executed by gratings or partially reflective mirror, beam splitters, or other specular reflectors.

A grating 22 is a corrugated structure to scatter light into specific directions. The corrugated structure is typically on the order of the wavelength of light, e.g., between 400 nm and 1000 nm, such that diffraction effects cause the scattering. In some embodiments, gratings are periodic. In some embodiments, a grating is a surface grating etched onto a substrate to in-couple or out-couple light into or out of the substrate. In some embodiments, the grating structure is produced by a geometric corrugation, a periodic index variation, a material peridociti8es, a birefringent periodicity, and the like. In some embodiments, the grating is a polarization volume grating, or is formed by varying a crystal axis of the substrate, which may be LC. In some embodiments, the grating is a subwavelength grating.

In some embodiments, a grating assist in waveguiding. In some embodiments, the grating is thick grating (Bragg regime), where the grating period is approximately the same as the wavelength of the light. Some gratings may be thin gratings and operate in the Raman Nath regime. Some such gratings are called volume Bragg gratings, volume phase holographic gratings, holographic optical elements, and the like. Some gratings comprise multiple periodic structures superimposed together. The thickness of the grating and how close an input wave matches the Bragg condition determines the efficiency of the grating.

A mechanical actuator 23 physically moves the elements to which are connected via an electrical or other types of signals. In some embodiments, the mechanical actuator is a piezo tube, a piezo transducer for SAW waves, and the like.

An electronic source 24 is a source of electric voltage or current. In some embodiments, it is a power supply, a battery, an alternating current (AC) signal, a current source, or other electronic signal.

A virtual image 25 is an image that triggers a depth cue of a viewer, who consequently perceives display content at variable depths, different parts of the display content at various depths relative to each other, or display content that appears at a different depth than a distance between the viewer and a component of the physical display system. For example, some depth cues are parallax effects. In some embodiments, 3D effects are triggered stereoscopically by sending a different image to each eye corresponding to a disparity. In some embodiments, depth cues are triggered using monocular depth cues, wherein each eye focuses or accommodates to the appropriate monocular depth. Virtual images may be multifocal, varifocal, lightfield images, holographic, stereoscopic, autostereoscopic, or (auto)multi-scopic. The virtual depth of a virtual image may be dynamically adjustable via a control in the display system, a user or sensor input, or a pre-programmed routine. “Depth modulation” refers to the change, programming, or variation of the monocular depth of a virtual image.

A virtual image is to be viewed by an observer, rather than be projected directly onto a screen. The light forming the image has traveled an optical distance corresponding to the monocular depth at which a viewer perceives the image. The geometric plane in space in which the virtual image is located is called the “focal plane.” Concentric lightfield displays may produce curved focal planes. A virtual image comprising a set of virtual images at different focal planes is called a “multifocal image” or “multilayer image.” E.g., a multilayer display system is one in which display content is shown in such a way that a viewer must accommodate his eyes to different depths to see different display content. A virtual image whose focal plane can be adjusted dynamically, e.g., by varying an optical or electrical property of the display system, is also called a multifocal image. A virtual display system that produces multifocal images may be called a “multifocal display system,” “multilayer display system,” and the like. A monocular depth at which content is located is also called a “virtual depth,” or “focal plane.” Multilayer displays comprise transparent displays in some embodiments. Content at a given virtual depth may be called a “layer,” “depth layer,” “virtual layer,” and the like.

A display system may produce a real image in the space outside the display system. (A real image forms where the light rays physically intersect, such that a film placed at that location will record a (collection of) bright spot(s), corresponding to an image.) The light rays diverge beyond that intersection point, such that a viewer sees a virtual image. That virtual image is first formed as a real image and will appear to the viewer as floating, or hovering, in front of the display panel, at the location of the real image location. This image is called a “hovering real image.”

FIGS. 2A through 2C show how the basic elements in FIG. 1 can be combined to produce structures, elements, architectures, subassemblies, or sub-systems. The specific components used to produce the effects desired in these subassemblies are nonlimiting examples, and they are not meant to exclude other components, geometries, or configurations to produce the same or similar effects. In some embodiments, these are integrated into a single, monolithic element, e.g., when a substrate is coated with various films or coatings. In some embodiments, they may be discrete components arranged with or without air gaps between them.

In FIG. 2A, a QBQ 26 comprises a QWP 8, a beam splitter 4, and another QWP 8. Light incident on a QBQ is partially reflected and partially transmitted, and the QBQ acts as a HWP for both the reflected and transmitted portions, converting x-polarized light (XP) into y-polarized light and vice versa. In some embodiments the beam splitter is a PBS. A QM 27 comprises a QWP 8 and a mirror 3. It reflects all light, and it converts XP into YP and vice versa (or, equivalently, horizontally polarized light into vertically polarized light). It does not change the polarization state of circularly polarized light (CP).

An electro-optic shutter 28 comprises an LC plate 13 and an absorptive polarizer 8. When the LC plate is ON, it rotates the polarized incident light such that it is aligned perpendicular to the absorptive polarizer and is absorbed by it. When the LC plate is OFF, it leaves the polarization unchanged and parallel to the absorptive polarizer which transmits it. An electro-optic reflector 29 comprises an LC plate 13 and a PBS 5. When the LC plate is ON, it rotates the polarization such that it aligned along the transmit orientation of the PBS. When the LC layer is OFF, the light passing through it is aligned such that the PBS reflects it. In some embodiments, a reflective polarizer is used instead of the PBS.

A fully switchable black mirror (FSBM) 30 comprises an absorptive polarizer 6 and a full switchable mirror 201, which may include an EO material, such as in the electro-optic shutter 28. In the ON state, the full switchable mirror 201 is on and reflects light of all polarizations. In the OFF state, the switchable mirror transmits the light, and an absorptive polarizer 8 extinguishes XP, transmits YP, and transmits only the y-component of circularly polarized light. A full switchable black mirror with quarter waveplate (FSMBQ) 31 comprises an FSBM 30 and a QWP 8. In the ON state, it reflects all light and interchanges XP with YP light (and vice versa). It reflects CP without changing the polarization state. In the OFF state it extinguishes CP, transmits YP, and coverts XP into YP and transmits the result.

Shown in FIG. 2B are two switchable reflective stacks. A switchable black mirror with quarter waveplate (SBMQ) 32 comprises a QWP 8, followed by two alternating layers of LC plates 13 and reflective polarizers 7, and finally one absorptive polarizer 6. The difference between the FSBMQ and the SBMQ is their corresponding polarization dependence. In the former the total reflectivity of the material is changing, agnostic to the polarization of the incident light, whereas the latter element produced a polarization-dependent reflectivity. In some embodiments a PBS is used for each of the reflective polarizers

For the SBMQ 32, when both LC plates are OFF (“transmit mode”), all incident polarizations transmit an x-polarized component; incident linear polarization reflect circular polarization. Incident circular polarization reflects light that depends on whether it is right- or left-circularly polarized. When the first LC plate is ON and the second OFF (reflect mode), all light is reflected as circularly polarized. When the plate LC plate is OFF and the second LC is ON (absorb mode), incident light that strikes the absorptive layer and is extinguished, and no light is transmitted through the layers.

An electro-optical reflector stack (EORS) 33 comprises a stack of N alternating PBS 5 and LC plates 13. All but one LC plate is in the OFF state, and the LC plate that is in the ON state reflects the incident XP. All other layers transmit light. By varying which LC layer is in the ON state, the EORS modulates the optical depth or optical path or the length that the light must travel through the stack before it is reflected by a cross-polarized PBS layer next to the ON LC layer. In some embodiments the LC plates and PBSs are configured to reflect YP.

It should be noted that the EO shutter 28, the EO reflector 29, the FSBM 30, the FSBMQ 31, the SBMQ 32, and the EORS 33 are all electro-optic and therefore may be used as an electro-optic programming element or modulation element. Further, any of these elements may constitute one element of a matrix or array of plurality of such elements to produce a spatially programmable layer, each element operating on a sub-region of image-forming light, e.g., on a pixel or a group of contiguous pixels. In some embodiments, the matrix is a two-dimensional array (an area), or a one-dimensional array (a row, or line).

Shown in FIG. 2C are further combinations of elements. In some embodiments, these form a variety of field evolving cavities (FEC) or layer stacks that can be used as subsystems for architectures explained throughout the disclosure. A switchable FEC 34 receives light from a light source 1 and comprises a QBQ 26 followed by an EO reflector. In the OFF state, the light directly exits the device to be viewed by an observer. In the ON state, the light is forced to travel one round trip in the cavity, and the displayed image appears to be deeper compared to the actual depth of the light source. In some embodiments, the monocular depth of the resulting image is approximately twice to three times the width of the cavity. If the light source is placed directly against a side of the cavity, the depth is approximately twice to three times as far as that of the light source itself. This FEC is an example of a coaxial cavity, in which the light always travels along or substantially along the optic axis.

A mechanized or actuated FEC 35 receives light from a light source and has components set on a mechanical actuator 23. In some embodiments, the cavity is polarization dependent or includes a QBQ 26 and a reflective polarizer 7. The mechanical actuator shifts a set of elements, either relative to the light source or relative to other, fixed, elements in the cavity, to create longer or shorter optical path lengths for the light and hence shorter or longer monocular depths.

An example of an off-axis FEC, which is also a multilayer FEC 36 consists of a light source 1, which is a display that is partitioned into segments or sub-regions, each subregion corresponding to an image at a certain depth. Light from the bottom segment is reflected by a mirror 3, and light from the upper segments is reflected by subsequent beam splitters 4. An absorbing element 202 absorbs unwanted stray light. In some embodiments, it is a black paint or coating. In some embodiments, it is vantablack and/or contains antireflective carbon nanotubes (CNTs), and it may be coated onto multiple surfaces within the FEC. In some embodiments the absorbing element is a uniform attenuator to substantially absorb all the light incident on it uniformly across its surface. In some embodiments, the FEC produces a multifocal image. The FEC can be arbitrarily engineered to represent the desired number of focal planes.

In some embodiments a cavity is a tilted FEC 37. Here an angled light source 1 is followed by a FEC comprising an “internal polarization clock” whose entrance face is a PBS 5, whose exit face is an EO reflector, and further comprising a titled birefringent element (which is a material whose refractive index depend on direction of travel and/or polarization, i.e., an anisotropic material) 203, which causes different angles of propagation to result in different phase retardation of polarization. In some embodiments, the EO reflector uses an EO element different from an LC. The electronic signal 24 turns the light into a desired polarization so that only one of the round trips are allowed to exit the cavity, and the transmitted light has traveled a desired optical path or depth. This is a representation of a FEC with polarization clocks and segmented gated apertures with desired gating mechanisms. In some embodiments, each of these elements is segmented, such that light from different portions of a segmented display travel different distances.

An example of an off-axis FEC with perpendicular emission 45 comprises at least one light source and at least one mirror 3, each arranged at an angle relative to an EO reflector 29. In some embodiments these angles are 45 degrees, or between 40 and 50 degrees. The EO reflector receives an ON/OFF electronic signal such that the LC (or other EO material) allows the light to change its path length and distance traveled before exiting the cavity. In some embodiments, the EO reflectors is replaced by an EORS, such that the light travel can be programmed or controlled in multiple steps.

Some subsystems profile the light before entering or after exiting the cavity. For example, in a mechanized subsystem 46 comprises a mechanical actuator 23 fixed to a light source 1. The actuator can shift the light source relative to an angular profiling element 10 to force the light to change directionality or to become collimated. In some embodiments, the angular profiling layer is a lenslet array such that the mechanical movement of the light source changes the object distance and therefore impacts the collimation or monocular depth. In some embodiments, the light source is a physically extended, like a display, and is “macro-formed,” meaning it may have mechanical waves or bends induced onto it by the mechanical actuators so that the directionality or collimation of the light that comes out of the angular lenslet array is impacted in a desired way. In some embodiments other elements, such as a beam splitter or mirror, are macro-formed.

In some embodiments, the display is mechanically shifting because of the actuator's motion along a translational axis, again to impact the directionality of the exit light from the apertures. The mechanical actuation mechanism may be arbitrarily engineered. In some embodiments, the mechanical actuator is an array of ultrasonic or acoustic transducers; in some embodiments, the mechanical translation is performed by a high rotation-per-minute brushless motor; in some embodiments, the mechanical movements are delivered via a piezo- or stepper motor-based mechanism.

In some embodiments, the precavity optics comprises different elements to achieve the desired profiling. Such modified precavity optics may have fewer or more components. A first precavity optical profiler 47 (or “precavity optics”) performs angular profiling consists of light source 1 layer followed immediately by an angular profiling element 10, which may be a directional film here. The angular profiling layer might be a lenticular lens array to provide stereopsis to the viewer, or it might be a microlens or lenslet array or any other angular profiling layer to provide autostereoscopic 3D or provide different images to different angles. In some embodiments, the angular profiling layer 10 attenuates light rays traveling within a certain angular range.

A second precavity optical profiler 48 receives light from a light source 1 and includes a micro-curtain 17 a QWP 8, and an antireflection (AR) element 18 to function as pre-cavity optics. This allows desired profiling of the light of the display. The pre-cavity optics can adjust the polarization, angular distribution, or other properties of the light entering the cavity. This subsystem may be used in many disclosed systems and is categorized as a display. The micro curtain can be arbitrarily engineered, and it allows for control of the directionality of the light and the visibility of the display. The AR layer allows for reduction of ambient or internal reflections of the systems that use this subcomponent. In some embodiments, the AR element is a coating on substrate. In some embodiments, the precavity optics does not have the QWP. In some embodiments, there is a physical space or gap between the precavity optics 49 and the light source.

An example of a postcavity optics 50 is a sub-assembly consisting of an AR element 18 and an absorptive polarizer 6 on one side facing a viewer and outside world, and a QWP 8 another optional AR element 18 or film on the side that faces the display from which light exits. In some embodiments, the AR element is a coating on substrate. In this disclosure, this postcavity optics is an example of aperture optics called an ambient light suppressor or an aperture optic. In some embodiments, the ambient light suppressor is the final set of optical elements that the light experiences before exiting the display system. In some embodiments, the ambient light suppressor further comprises a directional film or angular profiling layer to produce angular profiling of the light exiting the system. In some embodiments, only one of the AR elements is present. In some embodiments, further components are sandwiched between the disclosed elements to further profile the light.

The postcavity optics 50 functionally mitigates the nonuniformity (waviness) observed in the virtual image and decreases the ambient light noise received by the user. Some part of the ambient light reflects directly from the shield layer, and some part of the ambient light enters the cavity and comes back. In some embodiments, it is an aperture optic to transmit light from the display system to the outside world. It can be a stack of layers laminated or deposited together such that the light that enters the cavity changes polarization and is absorbed by the stack of polymers. In some embodiments, depending on the polarization of the signal light or the image light, it is tilted or bent to further decrease the ambient light and internal reflections of an FEC. In some embodiments, it is composed of absorptive polarizers 6, QWPs 8, or arbitrary antireflection coatings 18. In some embodiments, it has an absorptive layer 12 to further decrease the ambient reflection because the ambient light passes twice through the shield layer. In some embodiments, the postcavity optics 47 has a liquid crystal plate 13 or optically tunable layer such that the electric signal applied can be leveraged to choose the image depth that needs to exit the cavity. In some embodiments, there is a liquid crystal layer with oscillating polarization on the shield layer to provide both polarizations to the outside world.

FIG. 2D shows example subassemblies involving mechanical actuation. The components of the wearable, in particular the optical components such as a flexible waveguide, can be actuated in a number of waves. The waveguide itself may act as a loaded cantilever. In some embodiments, the actuation is photothermal, where the actuation is from the heating due to the signal itself. In some embodiments, it is piezo-actuated. In some embodiments, the waveguide comprises a hydrogel or other low-density polymer, whose length can be modulated. In some embodiments, the mechanical actuators are LC elastomers coupled with metal films and actuated through thermal gradients.

FIG. 2A shows an example of a mechanical actuation mechanism 51 in which a waveguide 21 is coupled to a mechanical actuator 23, which in some embodiments is a piezoelectric tube. Piezoelectric tubes are thin-walled cylinders made of piezoelectric materials, typically ceramic materials like lead zirconate titanate (PZT) or barium titanate. These tubes are activated by applying voltage to electrodes on their inner and outer surfaces, causing them to bend, extend, or contract depending on the electrode configuration and applied voltage. Piezoelectric tubes may have outer diameters ranging from 1 mm to 100 mm, inner diameters from 0.5 mm to 90 mm, and lengths varying from 1 mm to 100 mm. They may have one or more voltage sources 24 to activate them making them elongate, compress, shear, or tilt. As the piezoelectric tube is activated with different voltages, it scans the waveguide through multiple positions, for example, positions P1, P2, and P3.

Another embodiment of a mechanical actuation mechanism 52 has multiple mechanical actuators 23 that mechanically couple a first, second, and third subpart, 300A, 300B, 300C, of a wearable device. In some embodiments, each of the parts is a waveguide. In some embodiments, they are supporting mechanisms to physically support an optical subsystem. In some embodiments, the multiple actuators support a single flexible waveguide in order to provide it with more degrees of freedom. Each mechanical actuator may be piezoelectric and have one or more electrodes attached to provide a voltage signal. The plurality of voltage signals then causes the wearable parts (or the single flexible waveguide) to move in a prescribed manner.

Still another embodiment of a mechanical actuation mechanism 53 shows a mechanical actuator 23 end-coupled to a waveguide 21, which has elastic or stretchable properties. The actuator vibrates directing elastic waves 203 along the waveguide to impact its waveguiding properties, dispersion/collimation properties, or outcoupling properties. In some embodiments, the waves are surface waves that serve as a time-depending grating to assist in outcoupling light. In some embodiments, multiple actuators generate such elastic or mechanical waves, and the superposition principle is used to determine the net effect.

In another embodiment of a mechanical actuation mechanism 54, a physical mount 303, which may be an adjustable mechanical support, is connected to a plurality of mechanical actuators 23 that are mutually coupled to each other. As they are activated, they scan the position of a light exit module 302, which transmits light from the wearable's optical subsystem to a viewer. In some embodiments, the scanning is done along a primary direction (1D motion). In some embodiments, the coupled actuators allow for 2D or 3D motion of the light exit module. In some embodiments, the actuators are elastomers, such as dielectric elastomers or LC elastomers. An elastomer may comprise a thin elastomer film sandwiched between electrodes, such that when a voltage is applied, mechanical compression of the thickness and expansion of the surface occurs. In some embodiments, the actuation rate is greater than 1 kHz in some embodiments, LC components are incorporated, and/or the elastomer is sensitive to temperature, light, and mechanical motion/deformation.

Another embodiment of a mechanical actuation mechanism 55 is a mechanical actuator 23 coupled to a waveguide 21 directly. In a first state, when the actuator is not active, the waveguide has a length L1, whereas in a second state, the actuator is active, and the waveguide stretches to a length L2. In some embodiments, the waveguide comprises a high-strain material. In some embodiments, the waveguide is a polymer. In some embodiments, the polymer is a hydrogel and forms an optical fiber, photonic crystal, or other waveguide.

Another embodiment of a mechanical actuation mechanism 56 is a mechanical actuator 23 the modulates or scans the position of a waveguide (to, e.g., positions P1, P2, P3) that is responsive to a non-electronics source S, which may be light, heat, other electromagnetic materials, and the like, which may come from internal sources built in to the wearable, or external sources like direct or indirect sunlight or other ambient lighting. In some embodiments, S is actually the image-forming light itself.

In some embodiments, light itself is used to actuate the wearable. Light can make an object vibrate macroscopically through several mechanism: the photothermal effect (light is absorbed by an object, creating a temperature gradient, and thermal expansion/contraction), resonance amplification (irradiation of an object with light pulses at the object's natural frequency), optomechanical coupling (in quantum systems or using radiation pressure), and the like.

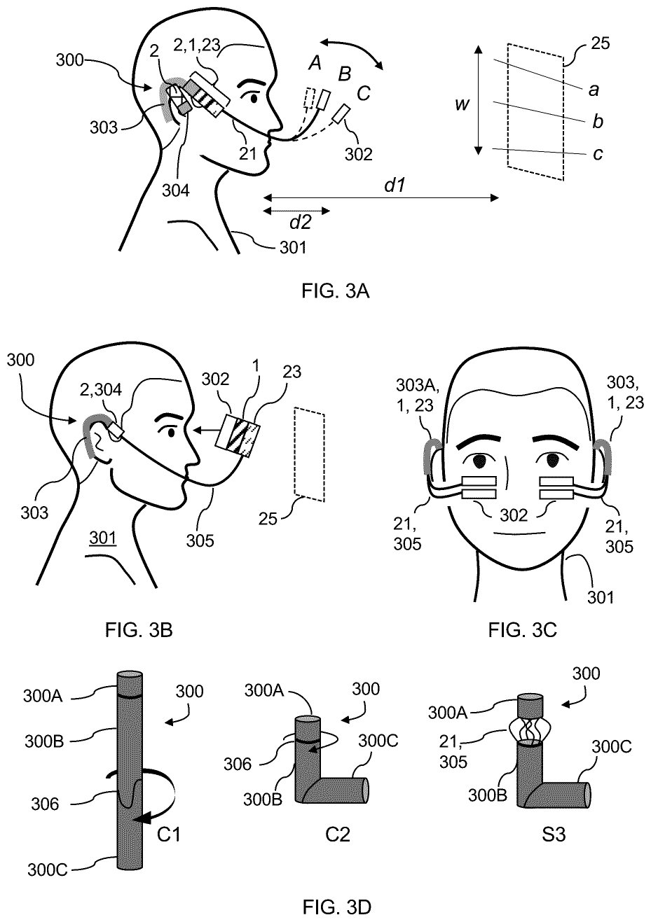

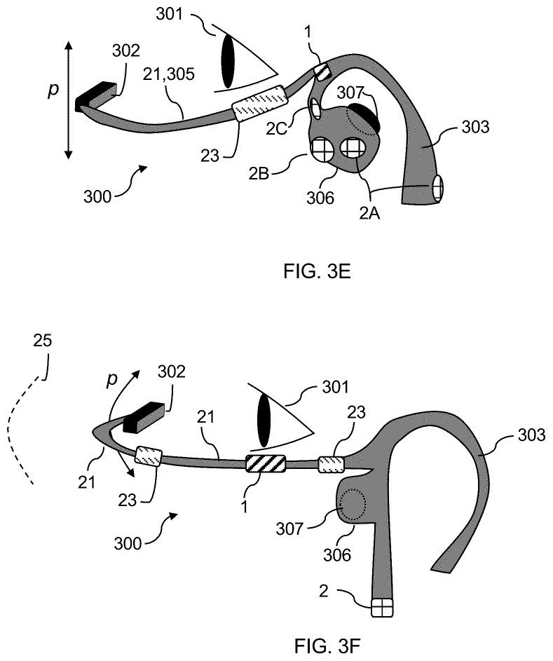

FIGS. 3A through 3F illustrate embodiments of combine these subassemblies into a wearable device 300 for a user 301 to use while wearing it. For example, in FIG. 3A a wearable device 300 includes and optical system having at least two components: a light source 1 that produces light and a light exit module 302 to transmit the light to a user 301. The light source and the light exit module are coupled to each other. They may be coupled by at least one waveguide/light guide or by free space. In some embodiments, the coupling is done physically, i.e., that are disposed one after the other and form a stack of optical components. In some embodiments, the stack has one or more optical layers disposed between the light source and exit module. In some embodiments, there are air gaps between the light exit module, light source, or any of the one or more optical layers.

In this embodiment, the light is guided from the source to the exit module via a flexible waveguide 21, i.e., one that is purposefully moved or deformed via mechanical actuation or other actuation mechanisms (thermal, chemical, electrical, optical, and the like). In some embodiments, the flexible waveguide is a plurality of waveguides, or is at least one optical fiber. Further, in some embodiments, the exit module is formed from the side of a portion of an optical fiber. A mechanical actuator 23 is activated by an electronic signal to modulate the position of the flexible waveguide and the exit module such that it scans periodically, i.e., back and forth through or repetitively within a fixed range, e.g., positions A, B, and C. In some embodiments, the scanning motion is lateral, i.e., occurs in a plane predominantly transverse to the user's line of sight, along a primary direction. A primary direction here means that each point on the light exit module traverses a curve in space that can be parametrized by a single quantity. For example, a point p on the light exit module may trace out a line or an arc. This is in contrast to, e.g., generating an image by scanning a (distal) fiber tip, w which must be scanned in a primary direction and a secondary direction (e.g., horizontally and vertically). In this case, further, the scanning rate, scanning geometry, scanning orientation, image brightness, and heat dissipation may differ strongly.

The scanning rate may range from, for example, 0.5 kHz to 1 kHz, 1 kHz to 5 kHz, 5 kHz to 10 kHz, more than 10 kHz, or more than 100 kHz. for example. During this scan, the optical subsystem creates a virtual image 25 visible to the viewer, each section a, b, and c of the virtual image generated while the exit module is in positions, A, B, and C, respectively. In some embodiments, the optical subsystem creates a virtual image visible to only one eye of the viewer. The virtual image may possess a monocular depth d1 that is greater than the distance between the viewer's eye and the exit module. In some embodiments, the monocular depth d2 is greater than the distance d2 between the viewer's eye and the exit module, such that the ratio d1/d2 is greater than 1, greater than 2, or greater than 3. A lateral size w of the virtual image 25 is directly related to the area swept out by the exit module.

The wearable device may be fixed to a body part or an accessory via a physical mount 303 and may further comprise an audio module comprising a sensor 2 service as a microphone (or microphone array) and a sound module 304, such as a speaker. Another sensor 2 or sensor array may be used to optimize or modify the virtual image based on, e.g., environmental properties or user activities. In some embodiments, the audio module and the optical subsystem are electrically coupled—with either physical or wireless connectivity—to interact with each other. In some embodiments, the sensor information is fed into a computational module that controls the mechanical actuation of the waveguide or another component of the optical subsystem. A mechanical actuator 23 is coupled to at least one of the optical components and causes them to move. The motion of the optical components in some embodiments is transverse to a line of sight of the viewer, and the area swept out determines the size of the virtual image 25.

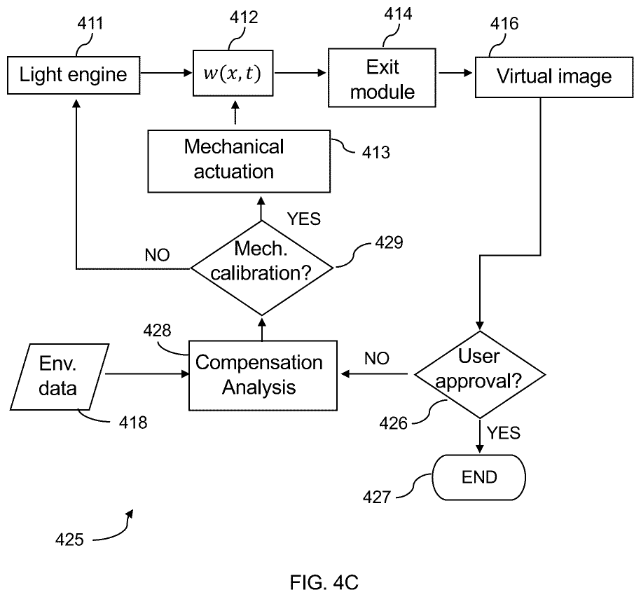

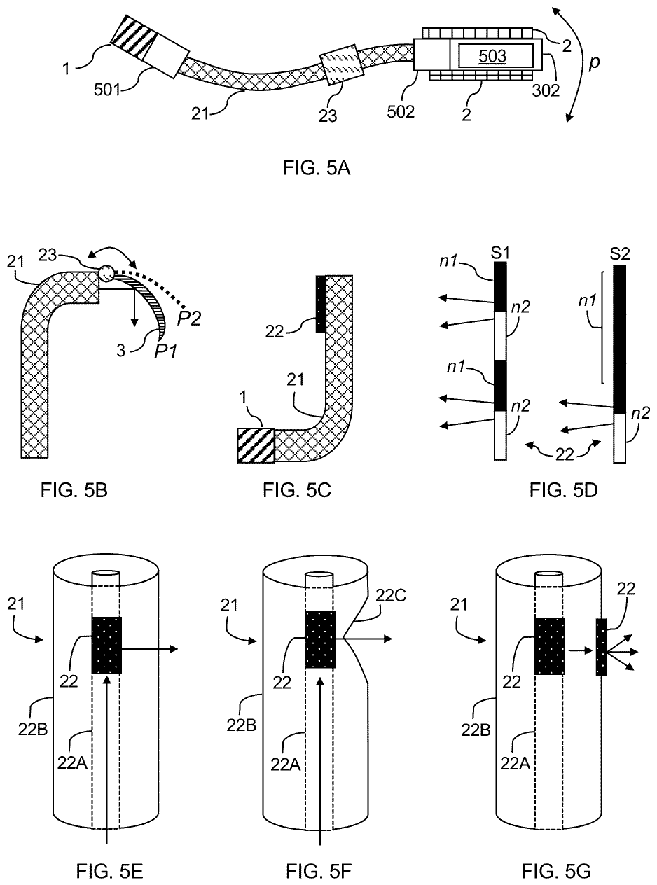

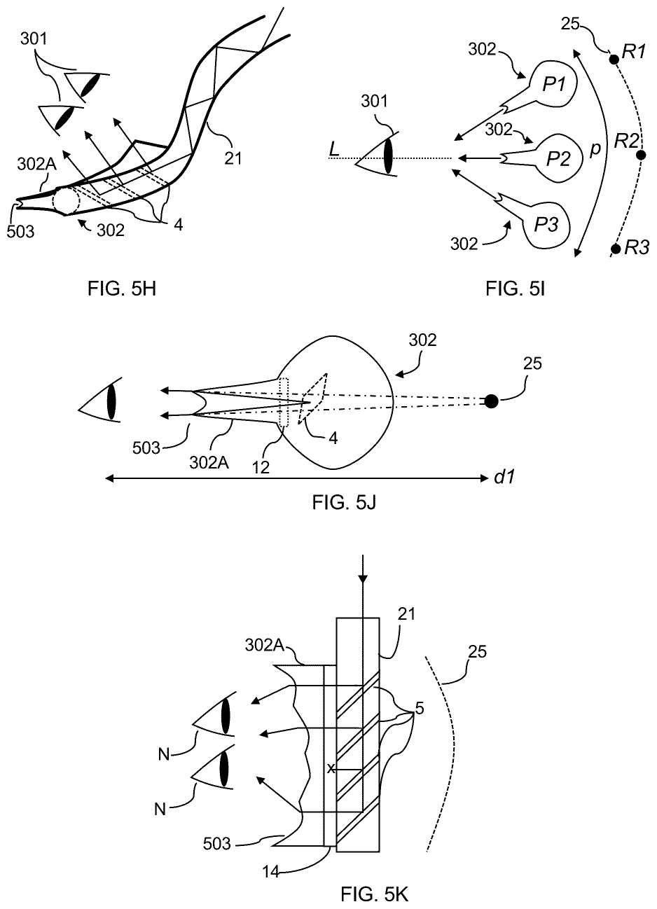

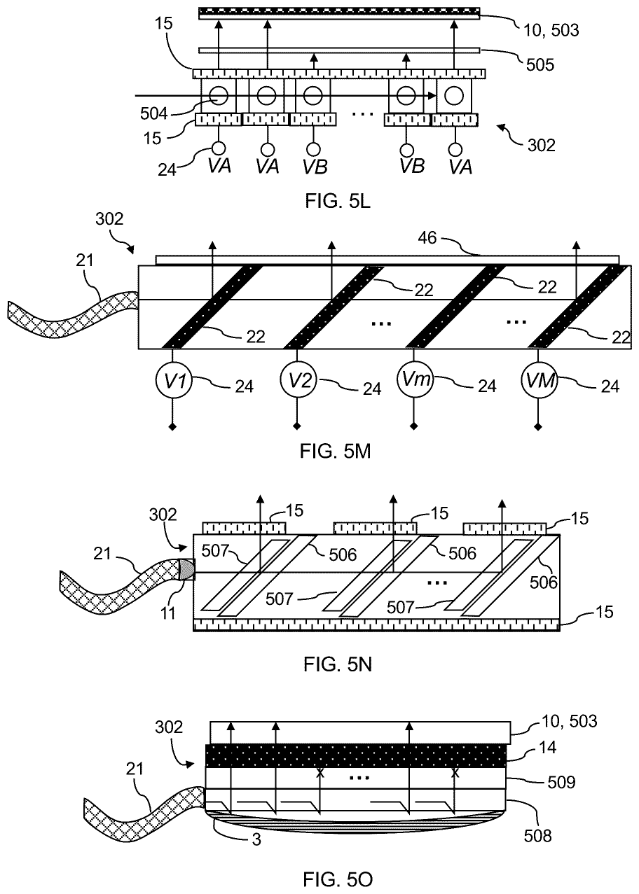

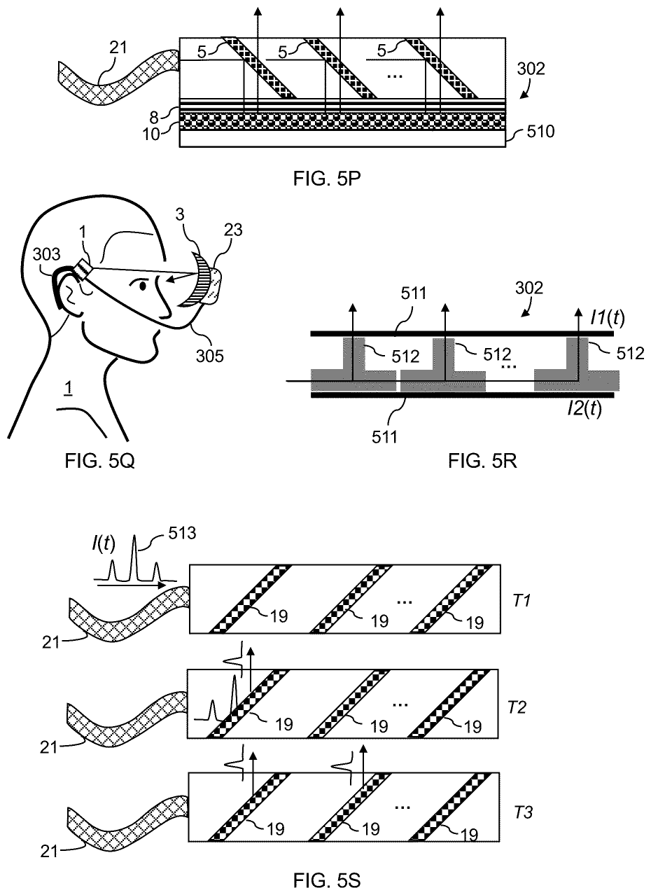

In some embodiments, the light exit module includes at least a portion of a side or an edge of the waveguide to which it is coupled. This is in contrast to emission from, e.g., the tip of a fiber. For example, the light may be coupled out from the side of the waveguide through a surface grating or stack of specular reflectors, which serves as the light exit module. (See, among other embodiments, FIG. 5A or FIGS. 5C through 5S). Further components, such as an EO matrix or other addressable matrix may be further used after the surface grating or specular reflectors to pattern the light. Further components, such as an aperture optic may be used to impact the virtual image quality, like brightness, curvature, or depth.

Having a side-emission light exit module relaxes the scanning requirements. For example, in a given position, the light emitted from the side may span a length L that is longer than a pixel. L may be more than 0.25 cm, more than 0.5 cm, more than 1 cm, more than 2 cm or more than 5 cm, for example. The length L may correspond to an entire linear length of the resulting virtual image. In may correspond to a significant fraction of a length of the virtual image, such as one half, one third, or one quarter.

For embodiments in which a side-emission light exit module emits light at a given instant corresponding to a length of the virtual image, then mechanical scanning is required in a primary direction that is a perpendicular direction to the length L. For example, if the length L corresponds to a horizontal (vertical) line of the virtual image, then vertically (horizontally) scanning the light exit module will sweep out the entire virtual image, i.e., mechanical scanning would be needed along only a primary direction. In such cases, the virtual image is formed as the light exit module sweeps out a lateral area, i.e., an area whose surface normal substantially coincides with the optic axis, a line of sight of the viewer. That is, the image focal plane itself is substantially perpendicular to the line of sight. In some embodiments, the focal plane is curved, e.g., to match a human horopter, such that the chief rays of the virtual image are directed to the viewer's eye or eyes.

In some embodiments, such as that in FIG. 3B the exit module 302 and the light source 1 are in closer proximity and coupled by means other than a waveguide. The wearable device 300 again has a physical mount 303 to affix it to a user 301 and an audio submodule with a microphone sensor 2 and sound module 304. The optical subsystem comprising the light source 1 and the light exit module 302 are both in front of the eye and coupled to the wearable via a rigid or flexible support 305. Flexible supports may also be called adjustable supports-they are semi-rigid and used to support a subcomponent or subsystem of the wearable relative to the viewer. They are further adjustable such that a user can adjust its shape or orientation to optimize the fit. The motion may be translational motion, vibratory motion, rotational motion, and the like, and combinations thereof.

In FIG. 3C, the wearable device comprises a plurality of subcomponents, for example a first physical mount 303A and a second physical mount 303B. In some embodiments, these mounts are supported by the left and right ears of the viewer 301. From each of the mounts (and any associated sensors, electronics, and optical components like a light source 1) may come one or more flexible supports 305 or waveguides, such that multiple light exit modules 302 direct light into one or both eyes of the user 301. Mechanical actuators 23 cause the exit light modules to move laterally to scan a virtual image. In this embodiment, each module may scan its own virtual image or a subset of them may scan a single image in coordination. For example, if there are two exit modules directing light into a single eye, the first one may generate the first half of an image, and the second one may generate the second half of the image, such that the virtual image spans a lateral area that is twice the lateral area swept out by either of the individual light exit modules In other embodiments, the lateral area of the virtual image be 3, 4, or 5 times the lateral area swept by any of a synchronized set of light exit modules. The number of light exit modules, their size and geometry, and their joint synchronization can be arbitrarily engineered. In some embodiments, the flexible supports are segmented supports, such that they comprise a series of flexible and rigid subcomponents along their lengths.

In some embodiments, the components and subsystems of the wearable are foldable, collapsible, or may be disconnected from each other, either automatically or manually. Such features improve the portability and storage of the device. Shown in FIG. 3D is such an example of a wearable 300, which can be decomposed into a first A, a second subpart 300B, and a third subpart 300C. In some embodiments, the parts can be screwed or unscrewed, connected or disconnected, joined or separated, and the like via a joint 306. In this embodiment, configuration C1 is the configuration of the wearable when it is intended not to be in use, i.e., for storage. By activating or turning a joint 306, the wearable is now in intermediate configuration C2. Further working of the joints leads to configuration C3, which exposes flexible supports 305 and or flexible waveguides 21, depending on the geometry, i.e., depending on which embodiment of FIGS. 3A through 3C (or a combination of them), the wearable belongs. This exposed portion's flexible supports or adjustable supports may bow outward as a stent, radially from the central axis and form a stent subcomponent to assist in functionality. In some embodiments, this portion of the collapsible or foldable wearabale serves as a functional component, such as the earpiece, ear support, or audio submodule.

FIGS. 3E and 3F illustrate further embodiments of a wearable device, in particular those that have an earpiece support. For example, the wearable 300 in FIG. 3E a physical mount 303, which may be connected to the ear or a part of the ear. In some embodiments, the physical mount has a composition suitable for human contact, like rubber, soft plastic, a semi-flexible material, and the like. A light source 1 to emit image-forming light is located within or near the physical mount and directs light along a flexible waveguide 21, which may be further supported by a flexible support 305. The waveguide and or flexible support may sometimes be called a cantilever. The light is received by the light exit module 302 with directs the light toward the eye of a user 301. At least one mechanical actuator 23 is used to modulate the position of the cantilever and, by extension, the light exit module, which is scanned laterally, or approximately laterally, along a path p. In some embodiments, the path p is curved with a curvature that is predominantly transverse to the line of sight of the viewer. The wearable has multiple sensors, for example, a first set of sensors 2A serve as an infrared (IR) array, which directs a pattern of IR light to a user's body part, such as hands, face, or eyes, and detects the reflected IR light. This detected light is used by a computational module to calculate, e.g., pupil position for eye tracking, head position for head tracking, or hand geometry for gesture recognition. Another sensor 2B or set of sensors are cameras or camera arrays. In some embodiments, these sensors are used for simultaneous localization and mapping (SLAM) to enable real-time mapping of the user's environment while simultaneously tracking the device's position within that space. This allows the wearable to accurately overlay digital content onto the real world, providing a seamless and immersive augmented reality experience for applications such as hands-free visual assistance or enhanced navigation in environments. In some embodiments, the wearable includes an audio submodule 306, which includes a sound module like a speaker or a speaker array 307, or a third sensor 2C like a microphone to detect and record audio, such as the user's voice. The audio submodule is positioned so as to provide sound into the ear of the user. In any embodiments, the various sensors, mechanical actuators, and sound modules may be integrated along different positions of the wearable.

Other sensors may also be integrated in similar fashion. In FIG. 3F, the wearable 300 includes a physical mount 303 to fix the device to a human user. In some embodiments, one or more sensors 2 may be clustered around a part of the wearable, and the audio submodule may fit snugly into the ear. A light source 1 is used to direct image-forming light to a light exit module 302, which scans along a lateral path that may be curved along a dimension perpendicular to the line of sight of the eye of the user 301. The light exit module can emit light that forms an image using e.g., metasurfaces, geometric optics, liquid crystal or other EO materials, further mechanical motion, and the like. In some embodiments, the light is directed from the source to the exit module along one more flexible waveguides 21 or geometric light guide (the main difference between whether it is called a waveguide or a light guide depends on the size of its features relative to a wavelength of the image-forming light); the waveguide(s), light source, and exit module collectively form an optical system of the wearable. In some embodiments, the optical subsystem's position or orientation (collectively called the “geometry”) is modified dynamically by one or more mechanical actuators 23. Such mechanical motion allows the exit module to be swept across a lateral area that is substantially perpendicular to the line of sight of the viewer. The mechanical motion of the flexible waveguides is effectively a cantilever vibration. The optical subsystem forms a virtual image 25, which may be curved or flat. In this embodiment, further, an audio submodule 306 comprises a sound module 307 (e.g., a speaker). Multiple sensors 2 are also integrated in the wearable.

In some embodiments, the audio submodule includes ultrasonic speakers or speaker arrays and performs spatial audio for the user.

A nonlimiting set of sensors used in this technology include the following. Inertial measurement units (IMUs) combine accelerometers, gyroscopes, and magnetometers to track head position and movement. Ambient light sensors adjust virtual image brightness based on environmental conditions. Depth sensors and cameras, such as time-of-flight (ToF) cameras and LiDAR, enable 3D mapping and spatial awareness for augmented reality applications. Proximity sensors detect nearby objects, while biometric sensors can monitor health metrics like heart rate. GPS modules provide location tracking for navigation and context-aware applications. Some embodiments also feature eye-tracking technology to control the display based on gaze direction.

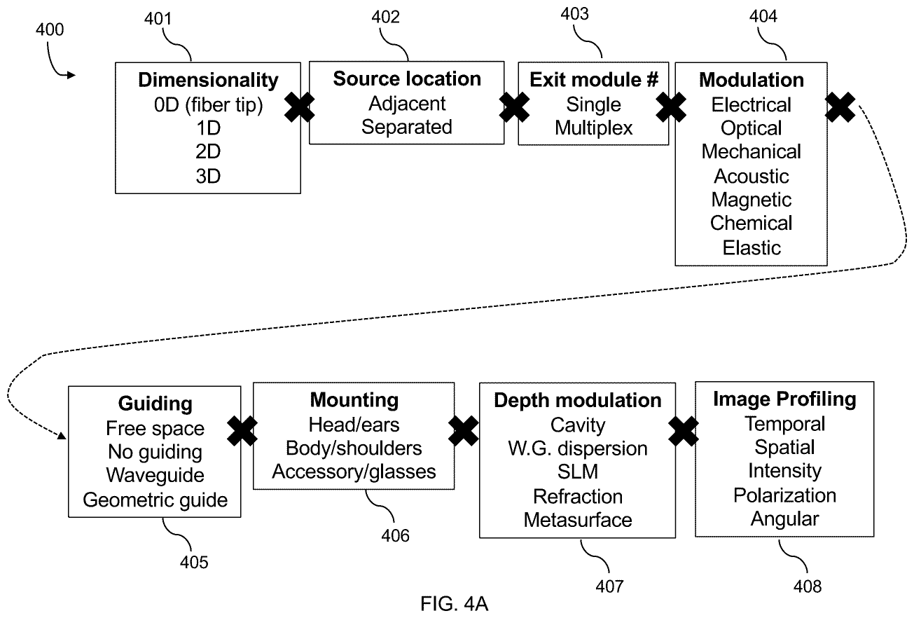

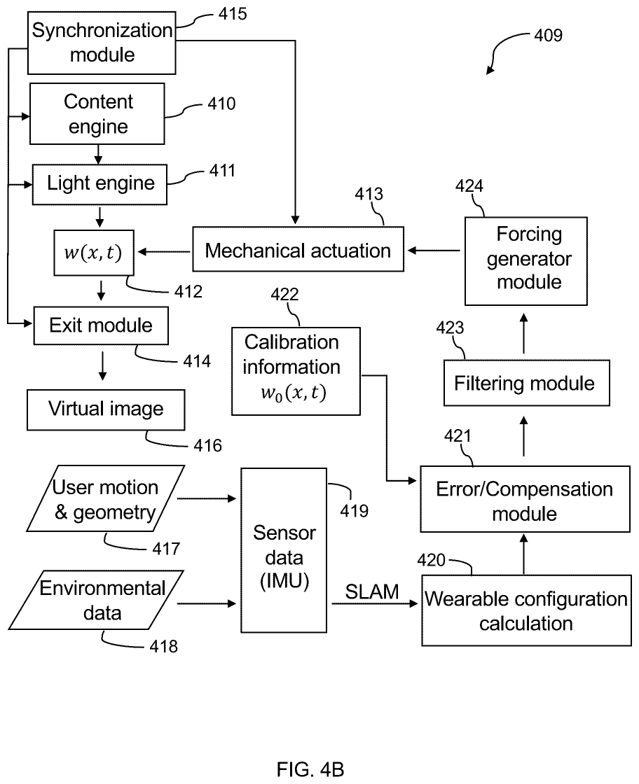

FIGS. 4A through 4C illustrate flow diagrams that discuss how the wearable's optical components, electronics/computational module, and mechanical motion interact with each other. FIG. 4A shows a first flow diagram 400 describing the generic operation of components of the optical subsystem and image-forming mechanism. First, the basic dimensionality choice 401 of the light exit module may be arbitrarily engineered. For example, it may be a zero-dimensional (0D) exit module, such as the tip of an optical fiber; a one-dimensional (1D) line emitter, such as what can be coupled out from the side a fiber, and edge-grating, or an edge-emitter; or a two-dimensional (2D) exit module, such as, for example, a smaller 2D array of pixels. In some embodiments, multiple exit modules of varying dimensionality are used. Next, the source location choice 402. The light source may be near or directly next to the light exit module, e.g., a curved or flat microlens array (exit module) on top of a 1D uLED display (light source). In some embodiments, the light source and exit module are separated by a distance and coupled by a waveguide like a flexible optical fiber. The exit module number choice 403 means that there can be one or more exit modules. For example, a wearable may have a single exit module for viewing by a single eye. It may have two exit modules, one for each other. Or it may have a plurality of exit modules for either or both eyes. Multiple exit modules are said to be multiplexed to produce one or more virtual images.

The modulation choice 404 of the light exit module determines the method of modulating the light to produce a virtual image. The modulation method may be electrical optical, mechanical, acoustic, magnetic (e.g., using magneto-optic materials), chemical (e.g., photochemical means), elastic, or combinations. The modulation choice depends on factors such as the size, mechanical scanning method and rate, desired image specifications and the light. For source-separated embodiments, the guiding choice 405 determines how the light is carried from the light source to the exit module. The embodiments described above (FIGS. 3A through 3E) have a waveguide guiding system, but in any of those embodiments, the waveguide can be replaced with a geometric light guide or even free-propagation. For source-adjacent embodiments, there is no guiding, although optical elements can be disposed between the exit module and the light source.

Similarly, the mounting choice 406 can be engineered in different ways. In many embodiments, the wearable is mounted to the user by an ear-based physical mount, but the mounting mechanism may also be affixed to other body parts, like the head, neck, shoulders, and the like. Further, the wearable in some embodiments is mounted to accessories, like glasses, hats, or existing headword devices and accessories.

To produce a virtual depth with monocular depth, the optical subsystem must perform depth modulation, and the depth modulation choice 407 varies. Depth modulation may be produced through one or more FECs, waveguide dispersion effects to tailor the wavefront or phase, SLM or DMD arrays, refractive measures (e.g., a microlens or tunable microlens array), or diffractive or metasurface methods. In some embodiments, the optical subsystem is multiplexed such that a virtual image is directed into each eye, and the two images are coordinated to produce a stereoscopic depth that matches the monocular depth of each image. Finally, the image profiling choice 408 includes all the ways the light can be modulated to produce desired effects and technical specifications like image depth, brightness, field of view, spectrum/color, viewable zone (eyebox or headbox), and the like. The light can be temporally profiled, spatially profiled, intensity profiled, polarization profiled, or angular profiled.

FIG. 4B shows a flow diagram 409 for the mechanical actuation of the optical subsystem in producing a virtual image. Effectively, mechanical motion of the device (1) must be synchronized with the light source and light exit module (emission) and (2) must compensate for any environmental or user perturbations, misalignments, and noise. A content engine 410 provides the data for the image content to the light engine 411, which comprises the light source and any required circuitry or other components for it to function. In the light engine block 410, the image light is generated from the light source. For source-separated optical subsystems, the light is directed along a waveguide (WG) or other guiding mechanism (as described in FIG. 4A). The guiding mechanism as a position w as determined in the position block 411. It directs the light into a waveguide which has a shape w(x,t) 412 at position x and time t. The quantity w may describe, for example, the waveguide's deflection relative to the point at which it is fixed to the wearable or a component of the wearable. The shape w is determined by a mechanical actuation 413, which forces the waveguide to vibrate, rotate, extend, expand, contract, and the like. The light is then coupled to the exit module 414. The content engine, light engine, mechanical actuation, and exit module are coordinated via a synchronization module 415 that makes sure the timing of all the electrical/optical addressing and mechanical motion is synchronized. The exiting light forms a virtual image 416 for a viewer.

Now, the viewer may move, change his geometry, desire different specifications of the image, or wish to interact with it using, e.g., hand gestures. Further, the environment has properties, such as wind, heat, turbulence, haze. and the like. At least some of these geometries and properties must be incorporated as feedback to optimize the light. Therefore, the user motion and geometry 417 and the environmental data 418 are detected by sensors (such as IMUs, IR sensors, camera sensors, ultrasonic range sensors, and the like), which produce sensor data 419. These data are input into a calculation such as SLAM to generate a wearable configuration calculation 420. This calculation determines the current state of the system, e.g., the position or shape of the waveguide, a detected gesture of the user, the user's pupil or head location or orientation, and the like. This information is then fed into an error/compensation module 421, which computes a difference or other metric between how the waveguide is being actuated at the moment and how the waveguide should move to compensate for environmental data, user motion, or user gestures. In some embodiments, calibration information 422, such as the ideal waveguide shape w₀(x,t), is input into the error/compensation module to impact the result. The changes that must be made in the mechanical actuation are output from this module and may be filtered by a filtering module 423, which in some embodiments uses a proportional-integration-differentiation (PID) filter. The signal then passes to the forcing generator module 424 which computes the precise mechanical actuation that must be enacted to produce the desired effect. In some embodiments, the forcing generator module or other module uses a physical module such as the beam equation,

$$\frac{{\partial }^{2}}{\partial {x}^{2}} ( EI \frac{{\partial }^{2} w}{\partial {x}^{2}} ) = μ \frac{{\partial }^{2} w}{\partial {t}^{2}} + q ( x )$$

to input into the mechanical actuation 413.

The light source will generate heat, so in some embodiments a heat sink module is connected to the light source to dissipate heat or radiate it away from the viewer. This may be, for example, heat fins or other geometric structure. Efficient heat dissipation can be effected in multiple ways: using high thermal conductivity materials like aluminum for any components, implementing miniaturized heat pipes or distributed components to spread out the heat generation, using low-thermal-conductivity plastics for the optical components or mechanical/flexible supports, and using high conductivity materials for components that are farthest from the viewer.

In some embodiments, IR sensors or other sensors perform SLAM calculations to determine the position of the user's face and/or eyes relative to a component of the optical subsystem, such as the exit module or the waveguide. The computational module detects a minimum safe distance between a body part and the component, and if this distance is closed, a computational module implements a safety-based actuation to avoid the component from making contact with the body part.

FIG. 4C shows a flow diagram for a calibration process to optimize the virtual image or to compute input data for a feedback loop in the mechanical actuation of the wearable. This step may be completed as a pre-use step, i.e., during setup of the wearable, or it may be done periodically during use or between uses. The light engine 411, as before, delivers light to a waveguide of shape w(x,t) 412, which moves according to a mechanical actuation 413, and the light is then coupled to the light exit module, which forms a virtual image. During initialization (before calibration), the mechanical actuation and the light engine's content may be preset or arbitrarily chosen. The image is viewed and judged whether or not to be appropriate in the user approval decision. If the decision is YES, the actuation is calibrated and the calibration process ENDS 427A. If the answer is NO, then a compensation analysis 428 is performed. This is similar to the Error/Compensation module 421 of FIG. 4C, but its algorithm and parameters may differ. Similar to FIG. 4C, environmental data 418 may serve as input data for the compensation analysis. The compensation analysis output is fed into a mechanical calibration decision 429. If the actuation may be calibrated further, the decision reports YES, and the mechanical actuation is adjusted. In some embodiments, the adjustment modifies a physical model of the waveguide's deflection. IN some embodiments, new parameters are added to the actuation function. If the mechanical actuation cannot be further adjusted, the decision answer is NO, and the information is sent to the light engine (or content engine) to adjust the image-forming light itself. For example, in some embodiments, a physical mount of the wearable is positioned in a way to the distort the viewed image, and the light engine adjusts the emitted light to compensate the distortion. In some embodiments, there are multiple exit modules, and the distortion compensation uses SLAM calculations to correct and align the images. In some embodiments, both the light and the mechanical actuation are simultaneously adjusted.

FIGS. 5A through 5S show different embodiments of the source-separated wearable embodiment of FIG. 3A. In the embodiment shown in FIG. 5A, a light source 1 emits light into an input profiling element 501 to adjust or optimize the light for coupling into a waveguide 21. The input profiling element in some embodiments is similar or identical to the first, second, or third precavity optics 47, 48, 49 of FIG. 2C. In some embodiments, it is an encoder that modifies the light for transmission among certain channels or modes of the waveguide. For example, in some embodiments, it is a plurality of diffractive layers, and the waveguide is a multimode or high-core fiber, each element of the image corresponding to a single mode or core. The light travels along a waveguide 21 or a plurality of waveguides. In some embodiments, a mechanical actuator 23 causes the waveguide to vibrate or deflect in synchronization with the light pattern emitted by the light source along a path p. The light is then outcoupled and passes through an output profiling element. This may be, for example, an angular profiling element a lens, an EO material, and the like. In some embodiments, it is one or more diffractive layers to decode the content from each channel of a multimode or high-core fiber waveguide. The light is then directed to a light exit module 302, and the light is transmitted to a viewer through an exit aperture 503. The exit aperture may comprise one or more components the ambient light suppressor 50 of FIG. 2C. The exit aperture in some embodiments comprises an AR element, an absorptive polarizer, or a wave plate (such as a quarter-wave plate). One or more sensors 2 near the exit module serve to help detect its position and orientation, velocity, and acceleration in space.

In some embodiments the light exiting the light exit module 302 through the exit aperture 503 is predominantly along an optic axis, which is perpendicular to the exit aperture. In some embodiments, at a given instant t, the light exiting the exit aperture forms one line of a virtual image. For example, in some embodiments, the exit aperture is equivalent to a 1×N pixel array, where N is greater than 1, or L×N, where LIN<<1, e.g., LIN<0.1, <0.05, or <0.01. Such a light exit module is called a 1D light exit module. In some embodiments, a light exit module comprises any of the addressable matrix embodiments disclosed herein. The addressable matrix in such cases would be a 1D addressable matrix and contain 1×N, or L×N, as the case may be. As the mechanical actuator 23 modulates or laterally scans the optical subsystem (e.g., the waveguide or exit module), the light emission is swept to trace out a virtual image that is approximately M×N (or LM×N), where M is a discretized number of positions of the exit module. M depends on the modulation speed of the actuator(s), the refresh or speed of the light source and the exit module's addressable components, which may comprise any addressable matrix, the maximum range of the exit module, and the like. In some embodiments, the virtual image size is not square or rectangular, but circular, elliptical, or fan-shaped.

Further, in some embodiments, the light from the light exit module directly enters the viewer's eye or eyes, i.e., there is no separate reflector, stationary or otherwise, to redirect the light to the viewer.

In some embodiments, the input and output profiling elements 501 are designed by a machine learning (ML) method. For example, any of the elements may be designed using one or more neural networks, a genetic algorithm, a gradient-based algorithm, and inverse-design algorithm, or combinations thereof.

In some embodiments, like in FIG. 5B, light exits the waveguide 21 and is reflected to the viewer by a mirror 3, which forms the light exit module. The mirror and the waveguide are coupled by a mechanical actuator 23, which may be a hinge or rotating ball joint to move the mirror to different positions, for example, position P1 and position P2. In this way, full virtual image is formed as the mirror scans multiple positions. In some embodiments the mirror is curved. In some embodiments, as the mirror is actuated, the position on the mirror where the light strikes it is modified.

The embodiment in FIG. 5C has a light source 1 that directs light along a waveguide 21. The light exit module here comprises a grating 22. In some embodiments, the grating is electrically addressable, modulated, or configurable. For example, the electrically addressable grating may comprise an array of EO elements, which may be LC elements, whose refractive index is varied based on applied electronic signals or voltages. In some embodiments, the grating comprises an array of phase change materials (PCMs), whose refractive index or other optical properties change with various stimuli, such as applied electronic signals, like a voltage. In some embodiment, the PCM is thermally based. An example is VO₂, various Ge_{X}Se_{Y}Te_{Z} (GST-XYZ) compounds (e.g., GST-225), various Ge_{W}SB_{X}Se_{Y}Te_{Z} (GSST-WXYZ) compounds (e.g., GSST-2214). In some embodiments, the VO₂ is dispersed in a substrate. Other PCMs include XVO₃ materials (X=Sr, Ba, Mg), SrNbO₃, various chalcogenide glasses (GeSbTe or AgInSbTe), certain sulfides (tin sulfide or antimony sulfide), certain oxides (tungsten oxide, or nickel oxide), and the like. The thermal source can be arbitrarily engineered. For example, the thermal source may come from thermal radiation or contact, optical or electromagnetic absorption, thermo-electric coupling, and the like. Further, the phase change itself may be, for example, between amorphous and crystalline states, or between conductor and semiconductor states. (Some of these materials also may serve as photoconductive materials that absorb in the IR to change the conductivity and is relatively transparent to visible or are very narrowband absorbers.)

FIG. 5D shows the operation of such a grating. When the grating is in a first state S1, it has a periodic refractive index change, between values n1 and n2. Light is emitted from all parts of the grating. When the same grating is in a second state S2, most of it has a uniform refractive index n1, and only where there is variation of index between n1 and n2 is light emitted. In this way, the addressable grating allows for generating spatially varying light patterns that form dynamic, time-varying, virtual images.

Other configurations exist for using gratings in conjunction with waveguides. In FIG. 5E, the waveguide 21 has an inner component 22A and an outer component 22B, such as a core and cladding, respectively. As the light travels along the inner component, it encounters a grating 22 in the inner part and is directed outward. This part of the waveguide, with the grating, is the light exit module in this case. In some embodiments, the grating is a fiber Bragg grating (FBG) or a tilted FBG. In some embodiments, like that shown in FIG. 5F, the outer part 22B of the waveguide has a notch 22C or taper to assist in outcoupling the light. In some embodiments, such as that shown in FIG. 5G, both the inner part 22A and the outer part 22B each have a grating 22 to help outcouple the light. In any embodiment, a grating may comprise multiple gratings, each to direct a portion of the light. For example, a grating may comprise three gratings two direct three different color channels of the light source, e.g., red (R), blue (B), and green (C).

FIGS. 5H through 5L illustrate further light exit modules. In these and other embodiments, the light exits the module from the side, which may be the side of a waveguide such as the side of an optical fiber. FIG. 5H is a perspective view in which the waveguide 21 directs light toward the light exit module 302, which comprises multiple semi-reflectors, such as beam splitters 4, to expand the eyebox and redirect the light toward one or both eyes of a viewer 1. In some embodiments, the light exit module comprises a subpart 302A to assist in profiling the light. In some embodiments, this is a physical extension protruding from the side of the waveguide, or has a curvature at the exit aperture 503 to help collimate or refract the light. In some embodiments, the semi-reflectors are instead gratings to use wave effects to diffract the light and expand the eyebox.

FIG. 5I is a side view of the embodiment to illustrate the scanning motion of the light exit module caused by a mechanical actuator. As components of the wearable's optical subsystem are actuated, they move, and the light exit module 302 sweeps through multiple positions, P1, P2, P3, as it traverses a path p. In some embodiments, a component of the light exit module, a flexible waveguide, and/or the light source generating the image-forming light are modulated in time, such that the virtual image 25 is composed of individual regions formed corresponding to the light exit modules time-varying position. That is, the region R1 is formed when the module is at position P1, region R2 at position P2, and region R2 at position P2. Each region may correspond to a line of the virtual image. For example, each region corresponds in some embodiments to approximately one horizontal row of equivalent pixels of the total virtual image. In some embodiments, the path p is perpendicular to a line of sight L of the viewer 1.

FIG. 5J shows a cutaway side view of the embodiment. In this example, the light exit module 302 comprises a semi-reflector, such as a beam splitter 4 (or a polarizing beam splitter or reflective polarizer) to direct the light through the exit aperture 503, which is connected to the wearable by a subpart 302A of the exit module. Here, there is also an EO element 12, which is electrically addressable and serves to modulate the light that the viewer sees. For example, this may be an EO reflector, an EO shutter, or an LC plate/matrix. The collimating effect of refraction, such as that at the exit aperture here, assists in creating a monocular depth of the virtual image 25 that is farther than a component of the wearable itself from the eye of the viewer 1.

Any addressable matrix may be partitioned such that each element corresponds to an arbitrary subsection of the image-forming light, e.g., to individual pixels, groups of contiguous pixels, and the like.

FIG. 5K shows a cutaway top view of the embodiment. The light from the waveguide 21 is reflected by a series of polarization-dependent beam splitters 5 and redirected toward an LC matrix 14, which subdivides the light into pixel elements and allowing spatial modulation of the image-forming light. The light then passes through a subpart 302A of the exit module, which has an exit aperture that is formed as a curved microlens array to help collimate the light and form a virtual image 25 for the viewer 1.

FIG. 5L shows a top view of an embodiment of a light exit module 302 that uses alternative means of generating an image using resonant nanoparticles or quantum dots (QDs). Light enters the light exit module 302 and strikes an array of resonant nanoparticles 504, each one absorbing some of the light and emitting it toward the exit aperture 503. Each of the nanoparticles is sandwiched between transparent conductors 15, which is grounded at the top and addressable at the bottom, such that each particle can have applied to it an independent voltage from a voltage source 24. With different voltages, the emission spectrum is tuned so that the emitted colors vary. To spatially modulate an image, a color filter 505 is used to filter out unwanted pixel light, which is tuned to be within the region band of the color filter. Further processing happens as the desired passes through an angular profiling layer 10 and an exit aperture 503. In this embodiment, the particles are photoactivated, i.e., they emit light after absorbing some light. In some embodiments, the particles are electroluminescent and emit light directly based on the voltage applied, without any incident light. Such embodiments would be classified as source adjacent, with the nanoparticles serving as the light source.

FIG. 5M shows a waveguide 21 directed light into a light exit module 302 which comprises a tilted fiber Bragg grating 22, which serves to direct the light to the viewer from the side of the light exit module and to expand the eyebox. In this embodiment, different regions of M total regions of the tilted FBG have a tunable voltage source 24 connected to it, such that, e.g., a first region has a voltage V1 applied to it, the second region V2, the m^{th} region Vm, and the last region VM. The tunability allows the light exit module to vary how much light is diffracted through the light suppression layer 50 toward a viewer to spatially modulate the image. In some embodiments, the light exit module is just an extension of the waveguide, such the core of an optical fiber, and further surface relief gratings on the cladding assist in outcoupling the light.

FIG. 5N shows a top view of part of the wearable. Light from the flexible waveguide 21 is directed into the light exit module 302, which comprises a series of resonant plasmonic layers 506. With an applied voltage across it, facilitated by transparent conductors 15, each of the reflectivities of the plasmonic layers can be tuned such that more or less light is emitted from each individual layer to spatially modulate the image. The tuning may help to adjust the bandgap of each of the plasmonic layers. In some embodiments, a lens assists in collimating the light to form a virtual image with monocular depth. Further, in some embodiments, each plasmonic layer has an elastic material 507 coupled to it, such that the applied voltage stretches the elastic layer causes a piezo-induced strain in the plasmonic layer to affect the modulated reflectivity.

FIG. 5O shows an embodiment in which light enters the light exit module 302, from, e.g., a waveguide 21, and is distributed across an edge-light light guide 508. The light is first directed downward toward a mirror 3, which may be curved, redirected upward through a diffuser 509 to make the light more uniform and remove and diffractive artifacts. The light then passes through an LC matrix to spatially modulate the light, then an angular profiling layer 10 such as a microlens array and an exit aperture to transmit the light to the viewer. In some embodiments, this embodiment has local dimming to assist in the modulation.

FIG. 5P shows an embodiment in which polarized light from a flexible waveguide 21 enters the light exit module 302, which comprises a plurality of PBSs 5 to first direct the light down through a QWP 8, which converts the light from, e.g., XP to CP, through an angular profiling layer 10 such as a microlens array, to a 1D spatial light modulator (SLM) 510. The SLM may be electrically programmable to imprint a spatially varying amplitude or phase modulation onto the light, which is reflected, travels through the angular profiling layer 10 again and through the QWP 8 again, which rotates the light into YP. The light then passes through the PBSs 5 and exits the module. Both the angular profiling layer 10 and the SLM 510 work in coordinated fashion to modulate the monocular depth of the image. In some embodiments, instead of the SLM, the light is reflected by a digital mirror device (DMD) and unwanted light is deflected to an absorbing layer.

FIG. 5Q shows a free-space source-separated embodiment, in which the user 1 is wearing the wearable device with a physical support 303 on his body. Near this support is a light source, such as a laser beam scanner (LBS), which can direct light along a particular direction that is swept out in time. Further, the wearable has an adjustable support 305 that has connected at one end a mechanical actuator 23 which actuates a mirror 3. The mirror is curved in some embodiments. The combination laser beam scanning and mirror actuation paint a virtual image for the user 1. In some embodiments, the LBS can use a Fourier-lens pair to assist in scanning or shifting six degrees of freedom of the beam. In some embodiments, the LBS has its own collimating lens. In some embodiments, the mirror is also dithered for vibration effect. In some embodiments, the light source position is fixed, and the mirror is a microelectrical mechanical (MEMs) mirror. In some embodiments, the mirror comprises an LC or a tunable/dynamic polarization grating to reflect and steer the light.

The optical subsystem of FIG. 5R uses magnetic effects to produce a virtual image. The light exit module 302 comprises an array of current-carrying wires 511, each carrying its own independent, time-varying current, e.g., I1(t) and I2(t) for, respectively, a first and second wire. In some embodiments, the wires are parallel. In some embodiments, there are a plurality of wires, each grouped into parallel subsets, with each subset oriented at a different angle from the others. In some embodiments, the currents are AC currents oscillating at radio frequencies. The current-carrying wires produce a time-varying magnetic field B(t) in the light exit module, which further comprises a plurality of circulators 512, which are non-reciprocal devices. In some embodiments the circulators are magneto-optic, e.g., Ce:YIG, terbium gallium garnet (TGG), yttrium aluminum garnet (YAG), other types of doped garnets, EuSe, and the like. The circulators act as Faraday rotators and direct the light either upward (reflectivity), out of the module, or toward the next circulator (transmissivity). By tuning the local magnetic field, each circulator will have a dynamic reflectivity/transmittivity to produce a spatially-varying pattern.

In some embodiments, such as that in FIG. 5S, the wearable uses nonlinear optical effects to produce a virtual image. At time T1, a flexible waveguide 21 inputs a light intensity signal I(t) into the exit module. This signal has nonlinear pump components 513 interspersed with the image-forming light. As the light travels through the system, some image-forming light is reflected by a first nonlinear element 19 at time T2. Just after this reflection, the first nonlinear element interacts with the nonlinear pump component. For example, it may absorb this light and change its reflectivity, allowing the rest of the light to be transmitted and reflected by a subsequent nonlinear element 19 at a later time T3. In some embodiments, the nonlinear material is LC. Other nonlinear effects that may be implemented are Kerr effect, saturable absorption, two-photon absorption, third-order optics, harmonic generation, and the like. In this way, the reflectivity R is a function of the incident light I: R=R(I).

In some of the embodiments using EO reflectors, either as shutters, pupil expanders, or to redirect the light, the EO reflectors are ultrafast ferroelectric LCs, and the reflectivity is tuned by a voltage signal to each element. In some embodiments, the voltage signal is a pulse width modulation (PWM) signal. These elements can operate in reflection, absorption, or transmission mode.

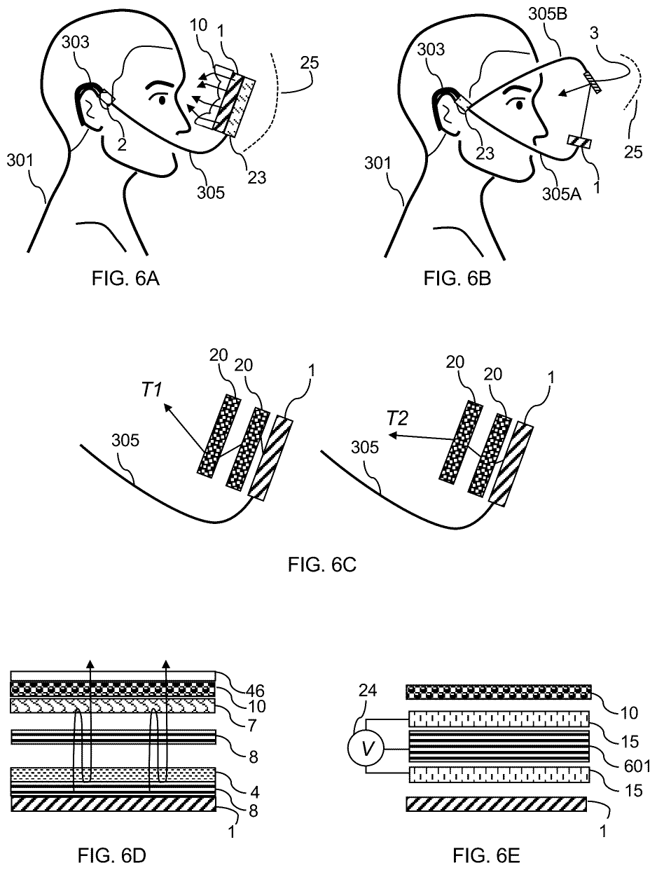

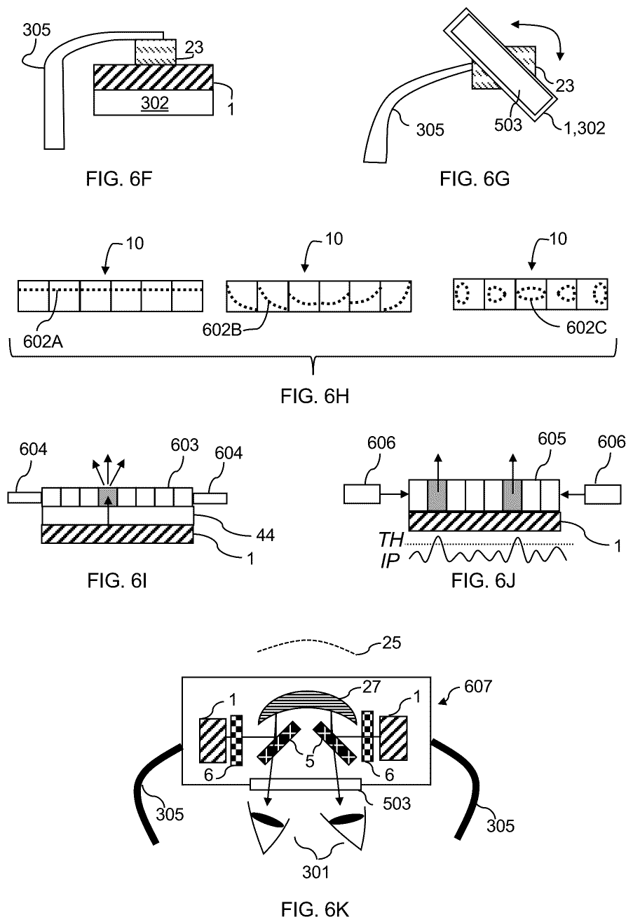

FIGS. 6A through 6K show embodiments in which the light source and the light exit module are close to each other, i.e., source-adjacent embodiments, where there is no extended waveguide coupling the two elements. In FIG. 6A, the user 301 wears the wearable, which is connected to his person by a physical support 303. The wearable has a sensor 2 or array of sensors to assist in the calibration, feedback, and interactivity described above. The wearable has an adjustable support 305 to position an optical subsystem in front of the user's eye or eyes. A mechanical actuator 23 is coupled to a light source 1 and an angular profiling layer 10, which in this case is a curved microlens array to produce a concentric light field. In this embodiment, at a given instant, the wearable produced a line of the virtual image 25. The mechanical actuator rotates the light source and angular profiling layer in a plane perpendicular to the light of sight of the user creating the extended image. The curved microlens array serves to generate a monocular depth for the image that is farther form the user the optical components themselves. In some embodiments, the lensing effects are produced by Fresnel-type lenses, holographic optical elements (HOEs)/DOEs, catadioptric systems, or free form shapes.

In FIG. 6B, the user 301 wears the wearable via a physical support 303, which also includes mechanical actuators 23. The wearable has two adjustable supports 305A, 305B, coupled, respectively, to a light source 1 and a reflector, such as a mirror 3, which may be flat or curved. The mechanical actuators cause the light source and mirror to vibrate or oscillate in a coordinated fashion to produce an extended virtual image.

Other embodiments use diffractive structures. For example, as shown in FIG. 6C, the adjustable support 305 may be coupled to a light source 1 that directs light into two DOEs 20, that can be changed in time to give four degrees of freedom (horizontal and vertical angles, and horizontal and vertical positions). At a first time T1, the DOEs work to direct light along a first path, and a second time T2, they direct light along a second path. Each path correspond to a part of the total virtual image. In some embodiments, the DOEs are metasurfaces, diffractive gratings, tunable LC layers, and the like. In some embodiments, the DOEs are replaced by a single time-varying volume holographic element.

FIG. 6D shows a coaxial FEC system, in which a light source 1, such as a display or uLED display. In some embodiments, the light source has an absorptive polarizer, to ensure its polarization is linear, say XP, and one or more directional films to optimize the light for the FEC. The light passes through a QWP 8 to convert the light to CP, then through a semi-reflector such as a beam splitter 4, then through another QWP 8 to convert the light to YP. It is cross-polarized, and therefore reflected by the reflective polarizer 7 and experiences a roundtrip in the cavity (between the beam splitter and the reflective polarizer). As it passes through the QWP 8 more times, it is eventually passed by the reflective polarizer 7, profiled by an angular profiling layer 10, such as a curved microlens array, and then passes through an ambient light suppressor 50. In some embodiments, one or more of the components are curved to assist in monocular depth formation. This optical subsystem may 1D and set to rotate on a mechanical actuator, as in FIG. 6A.

Some embodiments use interference effects to generate a virtual image. In FIG. 6E, a light source 1 sends light through a multilayer element 601 that is sandwiched between two transparent conductors 15. In some embodiments, one or more layers of the multilayer element is active and changes its optical properties, like refractive index, based on an applied voltage. The active material may be EO or LC and the like. A voltage signal 24 is applied to the multilayer element and/or the transparent conductors. In some embodiments, one of the transparent conductors and/or the multilayer film is addressable, i.e., subdivided into regions such that a film acquires spatially varying properties across it. By tuning the refractive index of the active layer, a region can be converted from a highly reflective material to a highly transparent material, thus producing spatial variation to the image-forming light. The transmitted light then passes through an angular profiling layer 10 such as a microlens array to further impact the virtual image. In some embodiments, multiple multilayer elements are used and the system is optimized for a uniform response across the visible spectrum. In some embodiments, the light source is coherent. This optical subsystem may 1D and set to rotate on a mechanical actuator, as in FIG. 6A.

FIG. 6F shows a top view of a source-adjacent embodiment, such as that in FIG. 6A. The adjustable support 305 is connected to a mechanical actuator 23, which is coupled to a light source 1 and a light exit module 302. The actuator causes the optical subsystem (that is, the light source, exit module and any profiling optics) to move. In some embodiments, the motion is a rotation in a plane perpendicular to the line of sight of the user. FIG. 6G shows a first-person view of the same embodiment. The mechanical actuator 23 rotates the light source 1 and light exit module 301 to form a virtual image. The light from the exit module exits through the exit aperture. In some embodiments, the actuator is a motor. In some embodiments, the optical subsystem includes a microlens display and/or a curved light source, like a 1D curved uLED display.

In some embodiments, an angular profiling layer uses non-inertial effects to create refractive effects for the image-forming light. For example, in FIG. 6H, an angular profiling layer 10 comprises individual cells of fluids or pairs of immiscible fluids. When it is not rotating the boundary 602A between the two is flat such that no collimation occurs. At a first nonzero rotation rate the modified boundary 602B changes the refractive properties, a third rotation rate leads to further boundary effects 603C. In some embodiments, the rotation rate is not constant. In some embodiment, other types of motion, like vibration or translation contribute to this refraction, leading to, for example, prismatic effects.

In the embodiment in FIG. 6I, a light source 1 emits light through precavity optics 44 and into an addressable acousto-optic modulator 603, which is a material whose refractive index is modulated by acoustic waves that are present within the material. The material is excited with acoustic waves by one or more mechanical transducers 604, which are types of mechanical actuators, arranged transverse to the optic axis (the primary direction of light from the light source). The transducers direct multiple acoustic waves transversely into the modulator, and superposition effects as they overlap produce an interference pattern and, consequently, a proportional refractive index variation. Each addressable element then experiences a potentially different refractive index, such that the light is diffracted out in a spatially varying manner. In this way, image-forming light may be spatially patterned. In some embodiments, this is a 1D subsystem that is set into motion by a mechanical actuator controlled by the computational modules on the wearable.

Other embodiments produce similar results. For example, in FIG. 6J, a light source 1 emits light into a generic modulator material 605, which is excited by transversely arranged generic transducers 606, which could be optical, ultrasound, AC electronic, and the like. As the signals from the transducers overlap, they produce an interference-like effect. In some embodiments, the generic transducers are themselves light sources, the pattern is an interference pattern, and the material is nonlinear. When the interference pattern IP reaches a threshold TH, those local regions of the generic modulator material change their properties to transmit or scatter light differently than in the other cases to spatially pattern the image-forming light form the original light source 1. In some embodiments, the effect is based on two-photon absorption of saturable absorption.

FIG. 6K shows an embodiment in which image light is visible by both eyes, either as a single monocular-depth image, or as a left-eye and right-eye image pair to include both monocular and binocular depth cues. Adjustable supports 305 extend from the wearable to its optical subsystem 607, which includes light sources 1 that direct light through absorptive polarizers 6. The light is reflected by PBSs 5 towards a curved QM 27, which rotates the polarization and redirects the light back through the PBSs through an exit aperture 503 to the eyes of the viewer 301. If both monocular and binocular depth cues are present, the eyes will simultaneously verge toward each other, and each respective lens will accommodate to see the virtual image 25.

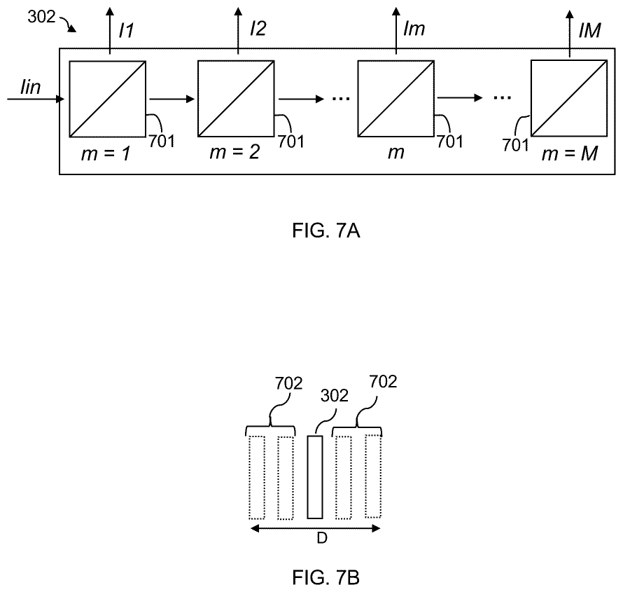

FIGS. 7A and 7B demonstrate some analysis of the embodiments disclosed here. In FIG. 7A, the light exit module 302 is subdivided into M subunits 701, which may serve as pixel elements for a line in the virtual image. Light Iin is incident on the module and first strikes the first subunit, m=1. Some of the light is reflected, I1, and some light is transmitted to the next subunit, m=2, which reflects some light I2, and so on. The system must be able to program arbitrary reflectivities, {R1, R2, . . . , RM} to spatially pattern the light and generate an image. Assuming a single incident light source and ignoring any light losses, the m^{th} reflectivity is

$${R}_{m} = \frac{{I}_{m}}{{I}_{in} - {\sum }_{j = 1}^{m - 1} {I}_{j}}$$

Any of the embodiments above may be used to generate a series of reflectivities to modulate the light, for example, addressable/LC matrix elements, nonlinear optics, time-resolved light sources, and the like. In some embodiments, LCs are dimmable LCs to impact the contrast relative to the ambient light.

FIG. 7B illustrates a scanning rate of a 1D light exit module 302, which is initially in its default location. As a mechanical actuator scans the module laterally, it moves to different positions 702 that span a distance D. If the desired image refresh rate is f, then the speed of the module must be, e.g., D/f (one frame per direction) or 2D/f (one frame per round trip). Further, if the module produces one line of the virtual image, i.e., approximately a row of pixels of the image, and N total pixels are desired along the scanning direction, then the modulation rate of the optical subsystem itself is Nf. In some embodiments, the refresh rate is about 100 kHz+/−20 kHz. In some embodiments, the speed of the module is about 2 m/s.

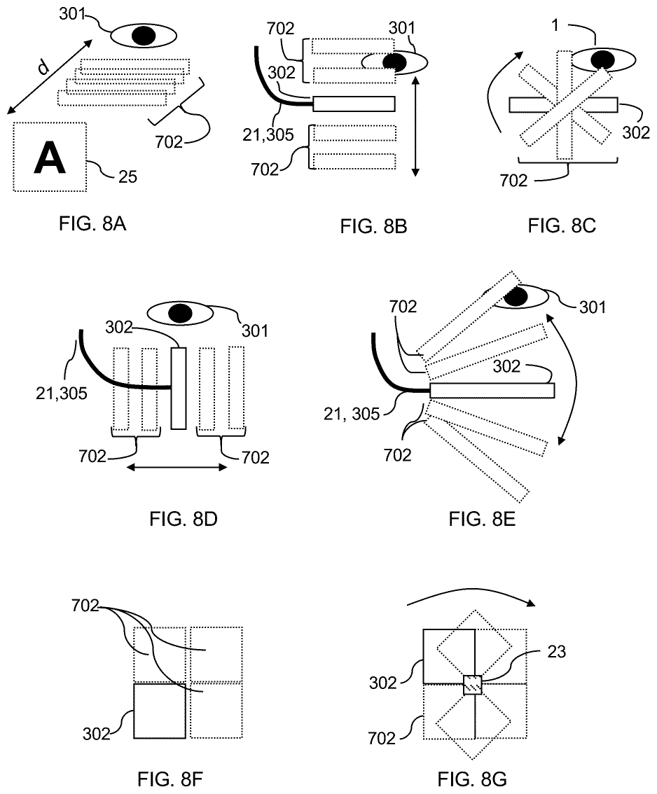

The aforementioned rates and reflectivities are influenced by the scanning geometries, some of which are shown in FIGS. 8A through 8G. FIG. 8A is a generic embodiment, in which the light exit module is scanned through a plurality of positions 702 to generate a virtual image 25 at a monocular depth d from the eye or eyes of the viewer 301. In FIG. 8B, the light exit module 302 is scanned through a vertical direction as the waveguide or adjustable support 21, 305 are actuated, such that the viewer 1 sees a virtual image where each position of the light exit module corresponds to a horizontal row of the image. In some embodiments, such as that in FIG. 8C, the light exit module 302 (including the light source in some source-adjacent embodiments) is rotated to sweep through a plurality of rotated positions 702. The resulting image has a circular shape according to the user 1. In embodiments such as these, some light emitting regions of the module are fixed in place, e.g., at the center, and others sweep through longer distances at the same rate. In such cases, the reflectivity or transmissivity of the transmitting elements of the module account for this geometric configuration. For example, the central region on average is dimmer than the edge regions, which are brighter.

The embodiment in FIG. 8D is similar to that in FIG. 8B, except that the motion is horizontal relative to the eye of a viewer 01, such that a light exit module 302 passes through a plurality of positions 702, and each position corresponds to a vertical line of the resulting virtual image. Here, components of the wearable, such as the waveguide 21 or the adjustable support 305 must be actuated in a horizontal manner.

In FIG. 8E, the waveguide and/or adjustable support 21, 305 are mechanically actuated such that the light exit module 302 traces out an angled path, traveling a longer distance at the far end, such that the user 301 sees a fan-shaped virtual image.

In some embodiments, the light exit module 302 maybe be a small 2D patch that traces out a larger area through multiple positions, as in FIG. 8F. In FIG. 8G, the 2D light exit module 302 is rotated about one corner, the rotation transverse to a line of sight, through multiple positions 702, and remaining largely fixed at the point where it is connected to the mechanical actuator 23.

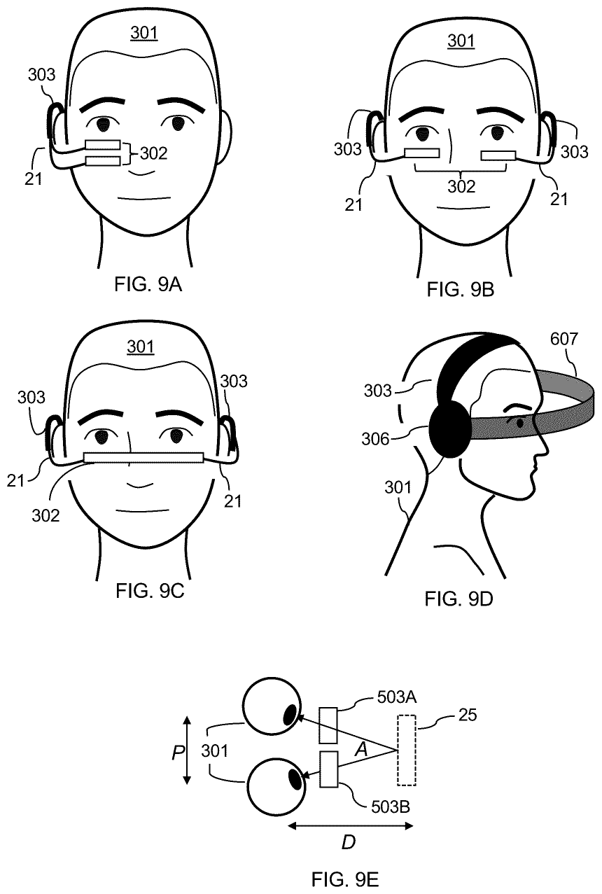

FIGS. 9A through 9E show embodiments of wearables that have multiple light emission regions, e.g., multiple light exit modules, which may be used to relax the scanning constraints on a given module or to provide image content to each eye simultaneously. In FIG. 9A, the user 302 attaches the wearable via a physical support 303. The wearable has a plurality of flexible waveguides 21, each terminating in a respective light exit module 302 among a plurality of them. In this embodiment, the plurality of light exit modules all direct light into the same eye, such that each one does not have to scan as far a distance. For example, if a single virtual image requires a total scanning distance of 1 cm, two light exit modules would have to scan only 0.5 cm, thus reducing the modulation rate by a factor of two. In some embodiments, the scanning rates or directions of each of the light exit modules differ to produce different lighting effects. In some embodiments, the range of each maybe be 500 um, spanning a total distance of 1 mm.

In FIG. 9B, the wearable comprises two physical supports 303 connected to a user 301. From each support extends a flexible waveguide 21, each waveguide ending in a light exit module 302. The mechanical actuation of the waveguides allows for a virtual image generated for each eye. In this example, stereoscopic images can be generated. A similar embodiment is shown in FIG. 9C, except that the plurality of waveguides connects to a single longer light exit module 302 that spans the distance of both eyes, e.g., 1, 2, or 3 times the interpupillary distance. A further similar embodiment is shown in FIG. 9D: the optical subsystem 607 spans a horizontal length of the head of the user 1. The wearable is attached via a physical support 303 over the head, and an audio submodule 306 covers the ears.

Embodiments in which virtual images are presented to both eyes are capable of monocular and binocular depth cues, as shown in FIG. 9E. The two eyes, specifically the pupils, of the user 301 are separated by an interpupillary distance P. Light emitted from a first and second exit aperture 503A and 503B are directed toward a first eye and a second eye, respectively, collectively forming a virtual image 25. If the monocular depth is D and the stereoscopic effect causes a vergence angle A, then the wearable eliminates the vergence-accommodation conflict by ensuring that a triangle is formed with base P, opposite angle A, and height D. (In some embodiments, there is a single exit aperture spanning P.)

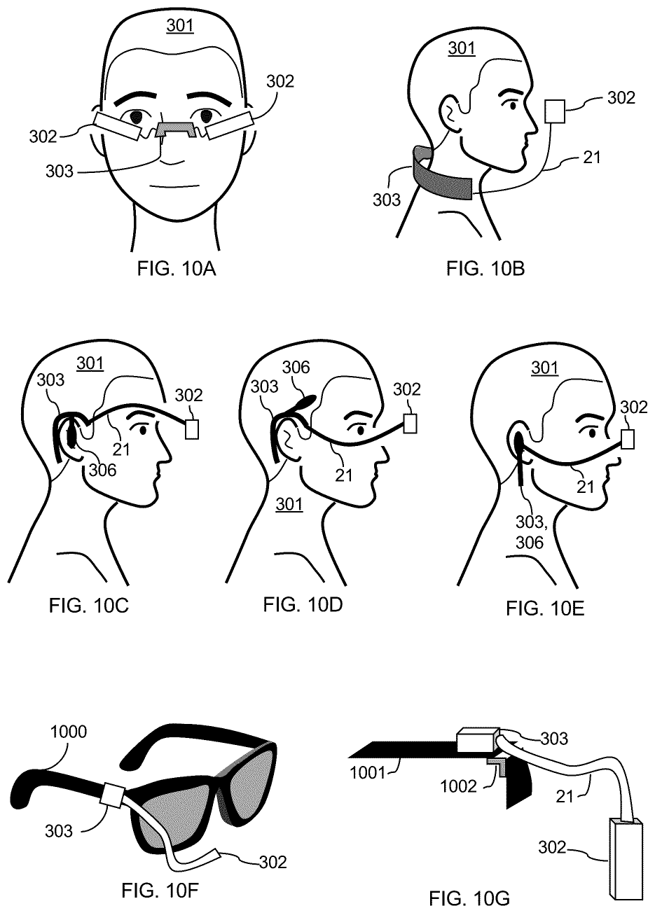

FIGS. 10A through 10G describe different mounting mechanisms. For example, the physical or mechanical support that fixes the wearable to the viewer may be an earpiece support, a shoulder support, a neck support, a nose support, or a head support. Although embodiments already described use a physical mount to attach the wearable to the ear or near the ear of the user, different configurations are possible. In FIG. 10A, the wearable uses a physical support 303 attached to the nose of the user 1. In this embodiment, a light exit module 302 is positioned in front of each eye. In some embodiments, only a single exit module is present for use by a single eye. In FIG. 10B, the wearable has a physical support 303 connected to the neck or shoulders of the user 301, and the flexible waveguide 21 is directed upward to position the light exit module 302 in front of the eyes.

In FIG. 10C, the wearable has a physical mount 303 to the ear of the user 301, and the flexible waveguide 21 is concave down, terminating in the light exit module 302. The audio submodule 306 is inserted as an earbud into the ear. Other audio submodules are possible. For example, in FIG. 10D, the audio submodule 306 is in contact with the temple of the user 301 and is configured for bone-conduction audio. The waveguide 21 is concave up. In FIG. 10E, the physical support 303 and audio submodule 306 are integrated together. In some embodiments, there are multiple physical supports supporting the same optical subsystem.

FIG. 10F shows an embodiment in which the wearable is attached to an accessory, such as a pair of glasses 1000. The physical support 303 is attached to the side of the glasses and the light exit module is directed in front. In further detail, in FIG. 10G, a stem 1001 of the glasses is connected to the physical support 303. The waveguide 31 gives clearance to the hinge 1002, and the light exit module 302 is aimed at the eye. The wearable may be configured for other accessories, such as clothing, jewelry, caps or hats, other head-worn accessories, and the like.

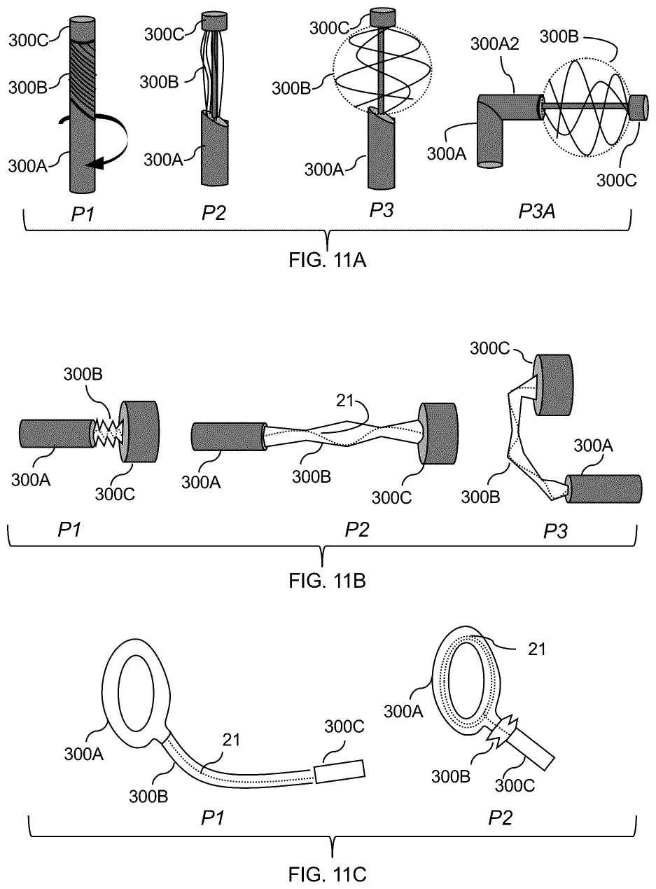

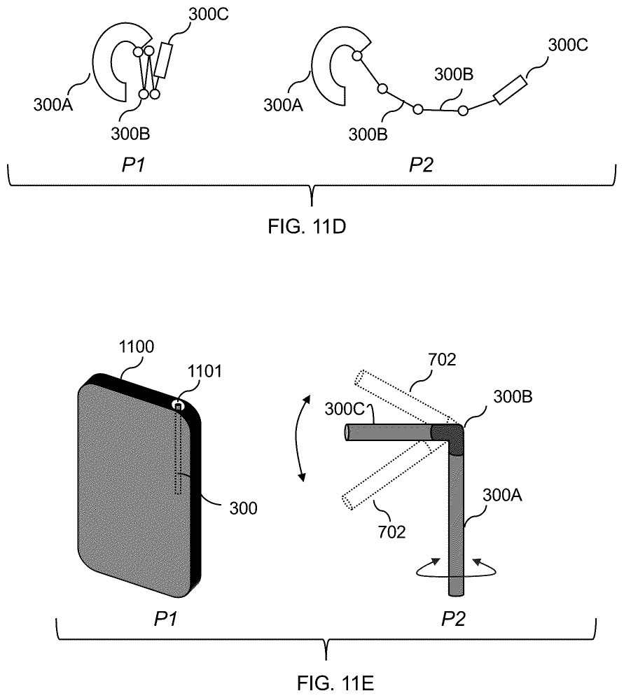

FIGS. 11A through 11E show collapsing or folding mechanisms of the wearable, similar to that in FIG. 3D, to allow for proper storage or portability of the wearable when not in use. In some embodiments, the different components disconnect mechanicals our magnetically. In some embodiments, the components are flexible or elastic, piecewise stiff, or have a dynamic mechanical property determined by an electrical signal. In some embodiments, pieces are joined by mechanical hinges. In some embodiments, a flexible component, such as a flexible waveguide, may be rolled up or folded such that the radius of curvature/folding does not damage the component. Such features make the device foldable, retractable, or compressible, i.e., give the wearable a smaller form factor for better portability and storage.

In FIG. 11A, the wearable comprises a first subpart 300A, a second subpart 300B, and a third subpart 300C, that are all aligned in position P1, suitable for storage. In an intermediate position P2, two parts are unscrewed or disconnected, such that the second part can be telescoped or elongated. In the use position P3, the second part is further unfurled. In an alternative use position P3A, the first part can be twisted and deformed into two subparts 300A1 and 300A2, to optimize the geometry for use as a wearable with an audio submodule.

In FIG. 11B, the wearable has a first subpart 300A, a second subpart 300B, and a third subpart 300C. The second part is collapsible, telescopic or otherwise deformable such that its length can be reduced to small form factor. In some embodiments, it is made of a piecewise flexible plastic or rubber, such that in position P1 all three parts of the wearable are compact. In second position P2, intermediate between storage form and use form, the second part is expanded and reveals the flexible waveguide 21 stored within it. The waveguide adheres to the second part at alternating positions so that as the part expands, the waveguide unfolds or unravels. Finally, in the third position P3, the second part 302B is bent so that the flexible waveguide is oriented in the necessary geometry for use. The third subpart 300C forms the physical support and/or audio submodule, and the first subpart 300A is the light exit module.

In FIG. 11C, the wearable is composed of three subparts, 300A, 300B, and 300C. The second part houses the flexible waveguide 21; the first part serves as the physical mount and earpiece, and the third part is the light exit module. In position P1, the device is in a configuration for use. The inside of the first piece is hollow and contains a ratchet mechanism, such that when the rest of the wearable is activated by a slight pull and release, the flexible waveguide is wound up inside the first piece, and the second piece is collapse or telescoped into a smaller form factor, position P2.

In FIG. 11D, the wearable's first subpart 300A may be the physical mount or audio submodule, the third piece 300C is the light exit module, and the second piece 300B is itself comprised of multiple linkages and hinges that can fold up into a small form factor in position P1 and unravel into a position P2 for use. In some embodiments, the linkages form the waveguide. In some embodiments, the third subpart 300C is the entire optical subsystem (i.e., in source-adjacent systems), and the second subpart 300B is just an adjustable support. The number of collapsible parts of a wearable may be 2, 3, 4, 5, 6, and the like. Generally, a collapsible wearable whose components can be moved or positioned relative to each other, such that the form factor of the wearable during use is different than that during porting or storage. In some embodiments, the optical components, e.g., the waveguide, light source, and light exit module are collapsible relative to each other, e.g., they can be folded, disconnected, bent, or deformed.

FIG. 11E shows a method of storing the wearable. In position P1, the wearable 300 is a long tube and can be inserted into a cavity 1101 of a portable device 1100 or the case that holds a portable device. Portable devices include cell phones, smart watches, tablets, laptops, and the like. When extracted, the wearable has a plurality of subparts, e.g., 300A, 300B, and 300C, the last of which serves as the light exit module that can take on different positions 702.

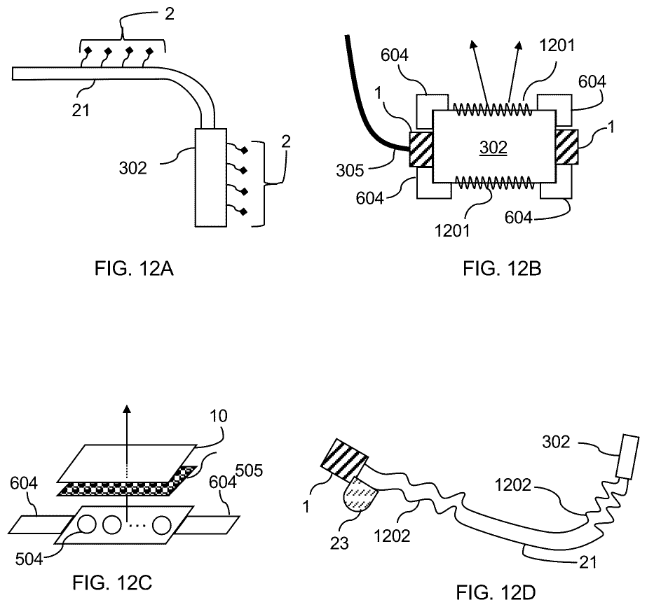

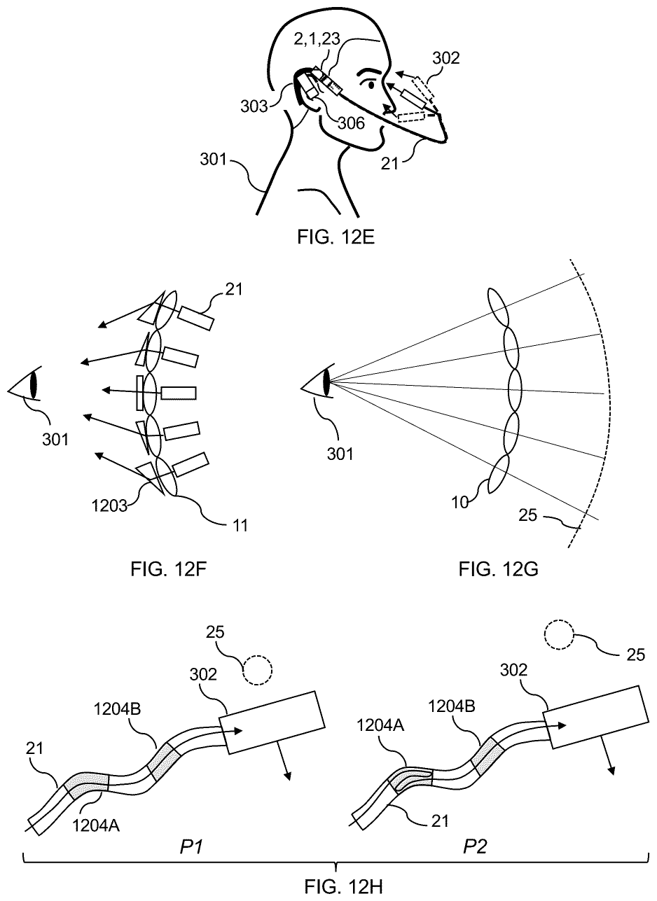

FIGS. 12A through 12H show auxiliary embodiments of the technology disclosed. In FIG. 12A, the waveguide 21 and the light exit module 302 each have a plurality of sensors 2 attached to them. In some embodiments, the sensors are flexible and can move relative to the optical components to which they are attached. These sensors can be IMUs, IR sensors, cameras, depth sensor, proximity sensors, ambient light sensors, and the like, and are used to track the environment and the wearable's position in the environment. In some embodiments, the received data is input in a machine learning network to understand the 3D properties of the environment and impact the mechanical actuation of the wearable accordingly.

Calibration, adjustment, or correction of the mechanical actuation and/or the modulation of the components of the optical subsystem impact the virtual image. In some embodiments, this impact is done by using any of the mentioned sensors to detect a property of an environment or of a user, said properties including environmental or ambient properties; user motion, geometry, orientation, or biometrics; or properties of the wearable itself.

In some embodiments, the calibration or correction of the mechanical scanning is produced by a machine learning algorithm. For example, a reinforcement learning network may be used to feed back into the mechanical actuators.

In FIG. 12B, an adjustable support 305 supports an optical subsystem comprising light sources 1 and a light exit module 302. Further, there are acoustic transducers 604 on the module that exit surface acoustic waves (SAWs) on the module. The light coupled into the module is then scattered by the SAWs to produce a virtual image. Similarly, in FIG. 12 C, acoustic modulators 604 generate SAWs on a layer of nanoparticles 504 such as quantum dots. The SAWs produce an interference acoustic pattern that locally tune the quantum dots' emission spectra. A color filter 505 removes unwanted colors (corresponding to dark regions of a virtual image), and an angular profiling layer 10 assists in adjusting the directionally of the light to form the virtual image.

In FIG. 12D, a light source 1 directs light through a flexible and elastic waveguide 21 to a light exit module 302. A mechanical actuator 23 excites the waveguide and produces surface elastic waves. These waves can modify the dispersion of the light within the waveguide to impact the virtual image.

In FIG. 12E, the user 301 has a wearable comprising a physical support 303, an audio submodule 306, and sensors 2. Further, the optical subsystem has a light source 1 that directs light along a waveguide 21, and into a light exit module 302. The mechanical actuator 23 causes the waveguide and exit module to vibrate. In this embodiment, the module may be the tip of a fiber (e.g., a GD emitter) and directs light directly into the eyes. In this embodiment, a dynamic refractive element is placed on the fiber tip to help direct the light into the eye at every position. This is shown in FIG. 12F, where the exit module is the tip of the waveguide 21 (e.g., a fiber tip). The dynamic refractor produces a lens 11 and a prism 1203, whose focal length and refraction angel, respectively, vary according to the position. In some embodiments, the dynamic refractor is a high-speed LC element. In some embodiments, it is a microfluidic element. The result is shown in FIG. 12G, where the user 301 sees a curved virtual image 25. The effect of the dynamic refractor is to mimic an angular profiling element 10 comprising a curved microlens array, that is concave according to the viewer's perspective. In some embodiments, the optical system is a source-adjacent system, and a quantum dot or other luminescent layer is located at the tip of an adjustable support.

Last, the embodiment in FIG. 12H shows a waveguide 21 directing light into a light exit module 302 which produces a virtual image 25. In some embodiments, the monocular depth of the virtual image can be adjusted by introducing dynamic FECs 1204A, 1204B within the waveguide itself. When all the FECs are OFF, position P1, the depth is relatively close. When at least one of the FECs is ON, P2, the light experiences a round trip in that particular FEC 1204A, and the path length is elongated, to make a deeper monocular depth for the virtual image. In some embodiments, the light is polarized, and the cavities rely on Pancharatnam-Berry phase relationships. In some embodiments, the cavities are nonreciprocal and include magneto-optic materials.

It is also possible to integrate these embodiments of this invention with other optical elements, such as parallax barriers, polarization shutters, or lenticular arrays to send different images to different eyes. In some embodiments, this is aided with an eye tracking module, and in some embodiments, the other optical elements are worn as a headset. These systems then may produce both monocular depth cues and stereoscopic depth cues to trigger accommodation and vergence binocular vision.

Although the invention has been explained in relation to its preferred embodiments, it is to be understood that many other modifications and variations can be made without departing from the spirit and scope of the invention as hereinafter claimed.

In this document, the terms “machine readable medium,” “computer readable medium,” and similar terms are used to refer to non-transitory mediums, volatile or non-volatile, that store data and/or instructions that cause a machine to operate in a specific fashion. Common forms of machine-readable media include, for example, a hard disk, solid state drive, magnetic tape, or any other magnetic data storage medium, an optical disc or any other optical data storage medium, any physical medium with patterns of holes, a RAM, a PROM, EPROM, a FLASH-EPROM, NVRAM, any other memory chip or cartridge, and networked versions of the same.

These and other various forms of computer readable media may be involved in carrying one or more sequences of one or more instructions to a processing device for execution. Such instructions embodied on the medium, are referred to as “instructions” or “code.” Instructions may be grouped in the form of computer programs or other groupings. When executed, such instructions may enable a processing device to perform features or functions of the present application as discussed herein.

In this document, a “processing device” may be implemented as a single processor that performs processing operations or a combination of specialized and/or general-purpose processors that perform processing operations. A processing device may include a CPU, GPU, APU, DSP, FPGA, ASIC, SOC, and/or other processing circuitry.

The various embodiments set forth herein are described in terms of exemplary block diagrams, flow charts and other illustrations. As will become apparent to one of ordinary skills in the art after reading this document, the illustrated embodiments and their various alternatives can be implemented without confinement to the illustrated examples. For example, block diagrams and their accompanying description should not be constructed as mandating a particular architecture or configuration.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in several ways. Different combinations and sub-combinations are intended to fall within the scope of this disclosure, and certain method or process blocks may be omitted in some implementations. Additionally, unless the context dictates otherwise, the methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computers processors, not only residing within a single machine, but deployed across a number of computational resources.

As used herein, the term “or” may be constructed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Although some embodiments comprise/include the disclosed features and may therefore include additional features not specifically described, other embodiments may be essentially free of or completely free of non-disclosed elements, i.e., non-disclosed elements may optionally be essentially omitted or completely omitted.

Further, it should be noted that terms of degree such as “substantially”, “about” a certain value and “approximately” as used herein mean a reasonable amount of deviation of the modified term or value such that the end result is not significantly changed. These terms of degree may also be construed as including a deviation of the modified term if this deviation would not negate the meaning of the term it modifies. It should also be noted that the terms “coupled” or “coupling” as used herein can have several different meanings depending in the context in which these terms are used. For example, the terms coupled or coupling may be used to indicate that an element or device can electrically, optically, or wirelessly send data to another 5 element or device as well as receive data from another element or device. Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Terms and phrases used in this document, and variations thereof, unless otherwise expressly stated, should be constructed as open ended as opposed to limiting. Adjectives such as “conventional,” “traditional,” “normal,” “standard,” “known,” and terms of similar meaning should not be constructed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A wearable multimedia system, comprising:
an optical subsystem having a light source and an exit module, the exit module coupled to the light source;
a mechanical actuator to periodically scan a lateral position of the exit module along a primary direction; and
a mechanical mount to attach the wearable multimedia system to a body part, wherein a virtual image is formed spanning a lateral area swept out by the exit module along the primary direction.

2. The wearable multimedia system of claim 1, wherein the exit module and the light source are coupled by a flexible optical waveguide.

3. The wearable multimedia system of claim 2, wherein the flexible optical waveguide is at least one optical fiber.

4. The wearable multimedia system of claim 1, wherein the mechanical mount is selected from a group consisting of an earpiece support, a shoulder support, a neck support, a nose support, a head support, and combinations thereof.

5. The wearable multimedia system of claim 2, wherein the exit module is formed at least in part by a side of the flexible optical waveguide and has a length of at least 0.5 cm.

6. The wearable multimedia system of claim 1, wherein the exit module comprises a plurality of semi-reflectors and a plurality of electro-optic modulators to modulate the virtual image.

7. The wearable multimedia system of claim 2, further comprising a plurality of mechanical joints such that the exit module, the light source, and the flexible optical waveguide are collapsible.

8. The wearable multimedia system of claim 2, wherein the exit module comprises a plurality of Bragg gratings to outcouple the light.

9. The wearable multimedia system of claim 1, further comprising an audio submodule.

10. The wearable multimedia system of claim 1, wherein the light source is a 1D line source.

11. The wearable multimedia system of claim 1, wherein the light source comprises three or fewer pixel sources.

12. The wearable multimedia system of claim 1, further comprising a plurality of sensors and a computational module (i) to detect a property of an environment or of a user, and (ii) to impact the virtual image based on said property.

13. The wearable multimedia system of claim 1, wherein the exit module comprises at least one waveguide to outcouple the light, the at least one waveguide modulated using a property selected from a group consisting of: an electrical modulation, a magnetic modulation, an optical modulation, a thermal modulation, a photochemical modulation, and combinations thereof.

14. The wearable multimedia system of claim 1, wherein the virtual depth has a monocular depth that is a factor of at least two times a distance between a viewer and the light exit module.

15. A wearable multimedia system, comprising:
an optical subsystem having a light source and an exit module, the exit module coupled to the light source;
a mechanical actuator to periodically scan a geometry of the optical subsystem; and
a mechanical mount to connect the optical subsystem to the human body, wherein a virtual image is formed spanning a lateral area swept out by the exit module.

16. The wearable multimedia system of claim 15, wherein the exit module comprises a microlens array to impact a directionality or a monocular depth of the virtual image.

17. The wearable multimedia system of claim 16, wherein the optical subsystem comprises a curved display.

18. The wearable multimedia system of claim 15, wherein the mechanical actuator scans the geometry of the optical subsystem using a rotating motion.

19. A wearable multimedia system, comprising:
an optical subsystem having a plurality of light sources and a plurality of exit modules, each exit module among the plurality of exit modules coupled to a respective light source among the plurality of light sources;
a plurality of mechanical actuators to periodically scan a plurality of exit modules along a plurality of primary directions; and
a mechanical mount to connect the optical subsystem to the human body, wherein at least one virtual image formed spanning a lateral area swept out by the plurality of exit modules.

20. The wearable multimedia system of claim 19, wherein a first exit module among the plurality of exit modules produces a first virtual image for a first eye of a viewer, and a second exit module among the plurality of exit module produces a second virtual image for a second eye of the viewer, the first virtual image and the second virtual image each having a respective monocular depth.

21. The wearable multimedia system of claim 20, wherein the first virtual image and the virtual second image jointly have a stereoscopic depth equal to the monocular depth.

22. The wearable multimedia system of claim 19, wherein a first exit module and a second exit module for a single contiguous virtual image visible by an eye of a viewer.

23. The wearable multimedia system of claim 22, wherein the lateral area is a first lateral area that is at least twice a second lateral area swept out by any of the plurality of light exit modules.
